(19) United States
(12) Patent Application Publication
(10) Pub. No.: US 2026/0111504 A1
(43) Pub. Date: Apr. 23, 2026

(54) SYSTEMS AND METHODS FOR UNLOCKING A USER EXPERIENCE WITH CONTACTLESS CARDS

(71) Applicant: Capital One Services, LLC, McLean, VA (US)

(72) Inventors: Michael Mossoba, Arlington, VA (US); Bob Uni Koshy, Henrico, VA (US); Thomas S. Poole, Chantilly, VA (US); Paul Y. Moreton, Tuscaloosa, AL (US); Sophie Bermudez, Bend, OR (US); Wayne Lutz, Fort Washington, MD (US)

(73) Assignee: Capital One Services, LLC, McLean, VA (US)

(21) Appl. No.: 18/921,350

(22) Filed: Oct. 21, 2024

(51) Int. Cl. G06F 16/955; G06F 3/0482; G06F 21/44; G06Q 20/32; G06Q 20/34

(52) U.S. Cl. CPC G06F 16/955; G06F 3/0482; G06F 21/44; G06Q 20/322; G06Q 20/352

(57) ABSTRACT

Systems and methods for unlocking a user experience are provided. A method can include receiving, via a short-range communication antenna of a mobile device, encrypted data from a contactless card, successfully decrypting the encrypted data to authenticate the contactless card, receiving, via the short-range communication antenna of the mobile device, a uniform resource locator (URL) from the contactless card, determining, using machine learning, one or more functions most likely desired by a user of the mobile device, and dynamically redirecting the URL to a website or a mobile application on the mobile device for performing the one or more functions most likely desired by the user of the mobile device.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless cards.

Many different types of transactions can be initiated, executed, and completed in connection with using contactless cards. However, a user experience in connection with such transactions can be difficult, confusing, and unsuccessful, especially on a mobile browser of a mobile device. Accordingly, there is also a need to simplify the user experience of contactless cards.

### BRIEF SUMMARY

In some embodiments, a method can include receiving, via a short-range communication antenna of a mobile device, encrypted data from a contactless card, successfully decrypting the encrypted data to authenticate the contactless card, receiving, via the short-range communication antenna of the mobile device, a uniform resource locator (URL) from the contactless card, determining, using machine learning, one or more functions most likely desired by a user of the mobile device, and dynamically redirecting the URL to a website or a mobile application on the mobile device for performing the one or more functions most likely desired by the user of the mobile device.

In some embodiments, the method can include relying on one or more user datapoints to determine the one or more functions most likely desired by the user of the mobile device. In some embodiments, the method can include receiving the one or more user datapoints from the mobile device, and in some embodiments, the method can include receiving the one or more user datapoints from a database storing information associated with a customer account associated with the contactless card.

In some embodiments, the method can include relying on one or more non-user specific datapoints to determine the one or more functions most likely desired by the user of the mobile device.

In some embodiments, the website or the mobile application for performing the one or more functions most likely desired by the user of the mobile device can include a menu of choices corresponding to the one or more functions most likely desired by the user of the mobile device.

In some embodiments, the method can include determining whether dynamically redirecting the URL to the website or the mobile application on the mobile device for performing the one or more functions most likely desired by the user of the mobile device leads to a successful transaction and, responsive thereto, updating the machine learning.

In some embodiments, a non-transitory computer-readable medium can include instructions that, when executed by a processor, cause the processor to receive, via a short-range communication antenna of a mobile device, encrypted data from a contactless card, successfully decrypt the encrypted data to authenticate the contactless card, receive, via the short-range communication antenna of the mobile device, a uniform resource locator (URL) from the contactless card, determine, using machine learning, one or more functions most likely desired by a user of the mobile device, and dynamically redirect the URL to a website or a mobile application on the mobile device for performing the one or more functions most likely desired by the user of the mobile device.

In some embodiments, the instructions can cause the processor to rely on one or more user datapoints to determine the one or more functions most likely desired by the user of the mobile device. In some embodiments, the instructions can cause the processor to receive the one or more user datapoints from the mobile device, and in some embodiments, the instructions can cause the processor to receive the one or more user datapoints from a database storing information associated with a customer account associated with the contactless card.

In some embodiments, the instructions can cause the processor to rely on one or more non-user specific datapoints to determine the one or more functions most likely desired by the user of the mobile device.

In some embodiments, the website or the mobile application for performing the one or more functions most likely desired by the user of the mobile device can include a menu of choices corresponding to the one or more functions most likely desired by the user of the mobile device.

In some embodiments, the instructions can cause the processor to determine whether dynamically redirecting the URL to the website or the mobile application on the mobile device for performing the one or more functions most likely desired by the user of the mobile device leads to a successful transaction and, responsive thereto, update the machine learning.

In some embodiments, a server device can includes a processor and a memory storing instructions that, when executed by the processor, can cause the processor to receive, via a short-range communication antenna of a mobile device, encrypted data from a contactless card, successfully decrypt the encrypted data to authenticate the contactless card, receive, via the short-range communication antenna of the mobile device, a uniform resource locator (URL) from the contactless card, determine, using machine learning, one or more functions most likely desired by a user of the mobile device, and dynamically redirect the URL to a website or a mobile application on the mobile device for performing the one or more functions most likely desired by the user of the mobile device.

In some embodiments, the instructions can cause the processor to rely on one or more user datapoints to determine the one or more functions most likely desired by the user of the mobile device. In some embodiments, the instructions can cause the processor to receive the one or more user datapoints from the mobile device and a database storing information associated with a customer account associated with the contactless card

In some embodiments, the instructions can cause the processor to rely on one or more non-user specific datapoints to determine the one or more functions most likely desired by the user of the mobile device.

In some embodiments, the website or the mobile application for performing the one or more functions most likely desired by the user of the mobile device can include a menu of choices corresponding to the one or more functions most likely desired by the user of the mobile device.

In some embodiments, the instructions can cause the processor to determine whether dynamically redirecting the URL to the website or the mobile application on the mobile device for performing the one or more functions most likely desired by the user of the mobile device leads to a successful transaction and, responsive thereto, update the machine learning.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system configured to operate in accordance with one embodiment.

FIG. 2 illustrates an example of a sequence in accordance with one embodiment.

FIG. 3A illustrates an aspect of a sequence in accordance with one embodiment.

FIG. 3B illustrates an aspect of a sequence in accordance with one embodiment.

FIG. 3C illustrates an aspect of a sequence in accordance with one embodiment.

FIG. 4 illustrates an example of a flow in accordance with one embodiment.

FIG. 5 illustrates an example of a flow in accordance with one embodiment.

FIG. 6 illustrates an example of a flow in accordance with one embodiment.

FIG. 7 illustrates an example of a flow in accordance with one embodiment.

FIG. 8 illustrates an example of a flow in accordance with one embodiment.

FIG. 9 illustrates an example of a message in accordance with one embodiment.

FIG. 10 illustrates an example of a routine in accordance with one embodiment.

FIG. 11 illustrates an example of a distributed network authentication system in accordance with one embodiment.

FIG. 12 illustrates an example of a method in accordance with one embodiment.

FIG. 13 illustrates an example of a mobile device in accordance with one embodiment.

FIG. 14 illustrates an example of a server device in accordance with one embodiment.

FIG. 15 illustrates an example of a computer architecture in accordance with one embodiment.

FIG. 16 illustrates an example of a communications architecture in accordance with one embodiment.

FIG. 17 illustrates an example of a system in accordance with one embodiment.

FIG. 18 illustrates an example of a method in accordance with one embodiment.

FIG. 19 illustrates an example of a method in accordance with one embodiment.

FIG. 20 illustrates an example of a sequence flow in accordance with one embodiment.

FIG. 21 illustrates an example of a processing flow to perform machine-learning operations in accordance with one embodiment.

### DETAILED DESCRIPTION

Embodiments disclosed herein are generally directed to systems and methods for unlocking a user experience with a contactless card. For example, systems and methods disclosed herein can dynamically redirect a uniform resource locator (URL) embedded on the contactless card to unlock the user experience most likely desired by a customer associated with the contactless card.

In accordance with disclosed embodiments, when a user wants to initiate, execute, or complete a transaction on a mobile device in connection with the contactless card, the user can tap or otherwise bring the contactless card into a communications range of a short-range communication antenna of the mobile device for near-field communication (NFC). The contactless card can transmit to the mobile device and/or the mobile device can receive from the contactless card encrypted data, and systems and methods disclosed herein can successfully decrypt the encrypted data to authenticate the contactless card.

In some embodiments, the contactless card can also transmit to the mobile device and/or the mobile device can also receive from the contactless card a user ID. In some embodiments, the user ID can be part of the encrypted data, and in any embodiment, the encrypted data can be embedded in or encoded on an applet on the contactless card.

Still further, the contactless card can transmit to the mobile device and/or the mobile device can receive from the contactless card the URL. As above, the URL can be embedded in or encoded on the applet of the contactless card.

Using machine learning, systems and methods disclosed herein can determine one or more functions most likely desired by the user and dynamically redirect the URL to a website or a mobile application on the mobile device for performing those functions. For example, in some embodiments, the website or the mobile application for performing the one or more functions most likely desired by the user can include a menu of choices corresponding to those functions. In any embodiment, the user can click on a link to access the website or the mobile application on the mobile device and/or the website or the mobile application can enable the user to click therein or thereon to initiate, execute, and/or complete the transaction.

In some embodiments, systems and methods disclosed herein can rely on one or more user datapoints to determine the one or more functions most likely desired by the user. That is, the one or more user datapoints can inform the machine learning. Exemplary user datapoints can include a customer status (e.g., new, existing, digitally active, app user, etc.), a customer log in history, a customer transaction history, a customer mobile phone type, customer discounts redeemed, customer points usage, website or mobile applications visited, and the like. In these embodiments, systems and methods disclosed herein can receive at least some of the one or more user datapoints from the mobile device and/or from a database storing information associated with a customer account associated with the contactless card. Additionally or alternatively, in some embodiments, systems and methods disclosed herein can rely on non-user specific datapoints to determine the one or more functions most likely desired by the user of the mobile device. That is, the one or more non-user specific datapoints can inform the machine learning. Exemplary non-user specific datapoints can include a time of day, a location, and the like.

As a specific, but non-limiting example, in some embodiments, systems and methods disclosed herein can determine that a brand new customer may want to be directed to an app store for downloading a banking app and, responsive thereto, dynamically redirect the URL to the app store and/or the banking app. As another specific, but non-limiting example, in some embodiments, systems and methods disclosed herein can determine that a customer may want to seek discounts related to items for which he/she is shopping and, responsive thereto, dynamically redirect the URL to a website or an app that identifies discounts for various products that can be unlocked by the customer. In a still further specific, but non-limiting example, in some embodiments, systems and methods disclosed herein can determine a merchant where the customer shops and, responsive thereto, dynamically redirect the URL to a search tool to seek out that merchant.

In accordance with disclosed embodiments, systems and methods can implement feedback loops for training the machine learning. For example, in some embodiments, systems and methods disclosed herein can determine whether dynamically redirecting the URL to the website or the mobile application on the mobile device leads to a successful transaction. Responsive thereto, systems and methods can update the machine learning.

Advantageously, systems and methods disclosed herein can utilize the contactless card as proof of identification to unlock the user experience specific for the user of the contactless card. Indeed, systems and methods disclosed herein can identify user context with various datapoints (e.g., where the user is located, what websites the user is visiting, etc.) and identify the user with data from the contactless card to direct that specific user to functionalities tailored for that user.

Additionally, systems and methods disclosed herein can reduce and minimize a number of actions that the customer must execute to unlock the user experience desired and, therefore, reduce and minimize an amount of user input that the processor of the mobile device and/or a server in communication with the mobile device must process. For example, in some embodiments, the customer need only execute 2 actions: placing the contactless card within the communications range of the short-range communication antenna of the mobile device and clicking on the link to access the website or the mobile application on the mobile device or in or on the website or the mobile application itself. Similarly, in some embodiments, the processor of the mobile device and/or the server need only process 2 pieces of user input—the encrypted data and the URL—to appropriately use the machine learning to unlock the user experience, thereby decreasing processing time and power consumed.

Details of the above-identified embodiments and additional advantages thereof are discussed in the following description.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identify, perform a payment, launch applications, login into applications, autofill a form or a field, navigate to a specified web location or app on a device, unlock a door, initiate a contactless card, verify themselves, and so forth.

The systems discussed here may enable users to perform these functions in a multi-issuer environment. Further, the systems discussed herein may enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that one issuer cannot access another issuer's data or functions. As will be discussed in more detail, these features may be provided by a switchboard system that is configured to process and perform each contactless card function in a secure manner. Additional benefits for issuers may include providing a highly secure authentication option for a mobile web, which typically lack the robust authentication options available in a native application.

Further, embodiments discussed herein support tap-to mobile web experiences on both major mobile platforms (iOS®, Android®) by leveraging App Clips® and Javascript® SDK with WebNFC®. In some embodiments, embodiments discuss herein can also support tap-to-mobile web experiences on mobile platforms by leveraging Instant Apps. For IOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for NFC between the mobile device and the contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC between the mobile device and the contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and other JavaScript UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

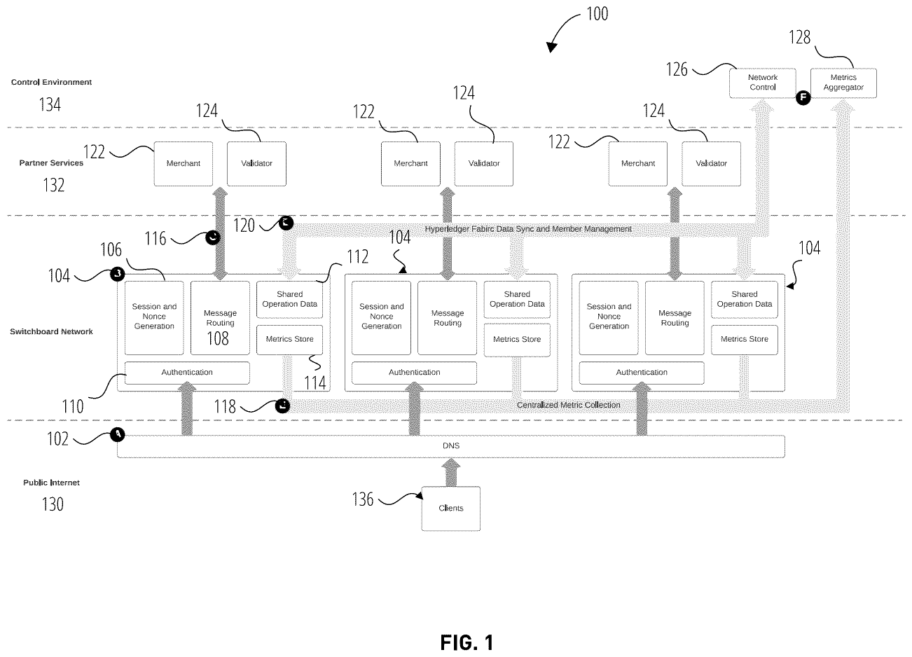

FIG. 1 illustrates an example of system 100 in accordance with the embodiments discussed herein. The system 100 includes additional devices and systems configured to enable contactless card issuers to provide tap-to-card services. Specifically, the system 100 enables any number of issuer systems to provide card services to their clients through a switching fabric, i.e., the switchboard system, in a secure and safe manner.

In embodiments, the switchboard system includes one or more nodes 104 configured to perform routing operations. Each switchboard node 104 may include a session and nonce generator 106, a message router 108, an authentication 110, an operation data store 112, and a metrics store 114. Further, each of the nodes may be configured the same and share configurations, but each switchboard node 104 may independently process and route messages and requests to the appropriate systems, such as the merchant systems and issuer systems. Each of the nodes 104 is configured to act as a broker of trust between an issuer system, the merchant system 122, and/or a validation system 124, for example. Each switchboard node 104 is configured to route each message to the correct issuer system while maintaining data security. For example, a switchboard node 104 may route a message between an issuer system and a merchant system while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 104. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, a router, and a firewall. The network switch is used to connect the server computers to other devices on the network. The router is used to route traffic between different networks. The firewall is used to protect the server system from unauthorized access and attacks.

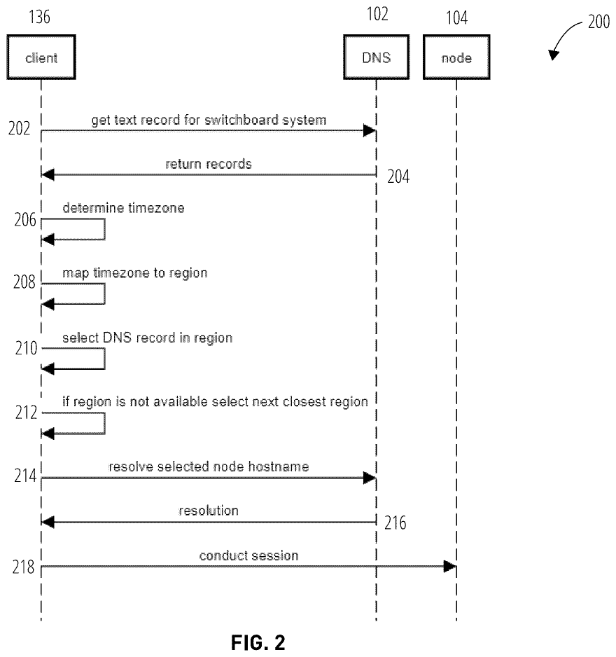

In some embodiments, the nodes 104 may operate in a cloud-based computing environment, e.g., a collection of hardware, software, and networking components that enable the delivery of cloud computing services. The switchboard nodes 104 and the computing services are delivered over the Internet, and they can be accessed from anywhere in the world with an Internet connection. In embodiments, a client 136 may access a switchboard node 104 through a Domain Name System (DNS) 102. The DNS 102 is a hierarchical and distributed naming system for computers, services, and other resources connected to the Internet or other networks. It associates various information with domain names assigned to each registered participant. In one example, the DNS 102 may translate a name known to software executing on a client 136 to route data to one or more switchboard node 104 of the switchboard system. In embodiments, the DNS 102 may generate a number, such as an Internet Protocol (IP) address, an address record (A-record), or another Host name (C-name record). FIG. 2 illustrates one example of a sequence 200 for a client to identify and resolve an identifier for one of the nodes 104 of the switchboard system. At a high level, the DNS 102 translates known domain names to numerical Internet Protocol (IP) addresses needed for locating and identifying computer services and devices with the underlying network protocols. Clients use the global DNS system to select the best node to use, as discussed in the sequence 200.

In embodiments, a client 136 communicates with the switchboard system to perform one or more of partner services 132, such as conducting a transaction with a merchant, validating the customer, or other tap-to functions. Once the client 136 identifies a switchboard node 104 and resolves an address to communicate with the switchboard node 104, the client 136 may send one or more messages to the switchboard node 104 to authenticate and perform the operation. The switchboard node 104 includes the authentication 110 that is configured to authenticate the client 136. In embodiments, the client 136 sends a message or authorization request to the switchboard node 104 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client | Individual |
| | ID | identifier |
| | | of client |
| GReyx5BuEAaE72bWbFZJfHRL8Dbt1Uum | Client | Randomly |
| | Key | assigned key |

The switchboard node 104 may authorize or authenticate the client 136 or user, and the switchboard node 104 may utilize the additional components, such as a session and nonce generator and a message router, to perform the operations. In some embodiments, validation systems 124 never interact with the merchant systems 122, nor vice versa. The nodes 104 brokers all communication.

In embodiments, the switchboard system may utilize a hyperledger fabric 120 to manage synchronizing shared operation data 112 and member management across the network. The hyperledger fabric 120 is a distributed ledger framework having a permissioned network model that ensures only authorized participants can join the network and access the data that is stored on the distributed ledger.

In embodiments, the hyperledger fabric 120 may be generated by creating one or more set of peers, an ordering service, and a channel. Once the network is created, the system 100 deploys chaincode to the network or the nodes 104 permitted to access the fabric. The chaincode is the code that runs on blockchain and executes logic code for a network control 126 and the shared operation data 112. Once the chaincode is deployed, each of the switchboard nodes 104 is configured to invoke transactions on the blockchain to add data to the blockchain, e.g., the shared operation data. A switchboard node 104 or another device can query the distributed ledger to retrieve data. The distributed ledger is a distributed database that stores all of the data that has been added to the blockchain.

All nodes 104 keep an independently verifiable log of their actions that can be transmitted to a centralized aggregator to build a picture of overall network usage. At a central level, the system 100 can manage network operation data and management and have a centralized view of network use, aggregated and abstracted to the appropriate level.

FIG. 2 illustrates an example of a sequence 200 for a client to utilize a DNS to resolve and communicate with one or more nodes of a switchboard system. The illustrated sequence 200 includes a client, a DNS, and a switchboard node. At 202, the sequence 200 includes the client sending a request to a default DNS server for a text record switchboard.{domain}. {tld}. The text record may be preconfigured in a client app and/or client sdk. At 204, the DNS returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node

In embodiments, the client may determine a current timezone at 206. For example, the client app or sdk may utilize a get current timezone function, such as in JavaScript: Intl.DateTimeFormat( ).resolvedOptions( ).timeZone). Embodiments are not limited in this manner, and the app or sdk may determine the current timezone via another/different function call. At 208, the client is configured to map the current timezone to a region or a short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, regions can also be represented as a bidirectional graph structure with the edges representing geographic neighbors. For example, na-e<->na-w and sa<->na-w and sa<->na-e. This representation is useful for node selection.

At 210, the client may identify or select a DNS record option returned at 204 that is in the region. If there are multiple matches, the client may select one at random. If there's no node available in the region, the client may determine and use a data graph of neighboring regions to select a node in the closest region where a node is available at 212. For example, sa has no node but is connected to na-e where there is a node and so na-e is selected.

At 214, the client may resolve a selected node's hostname. In embodiments, the client may automatically resolve the hostname using a HTTP request default resolver of the client. At 216, the DNS may return a result, and at 218, the client may communicate with the switchboard node and begin the process to interact with the switchboard.

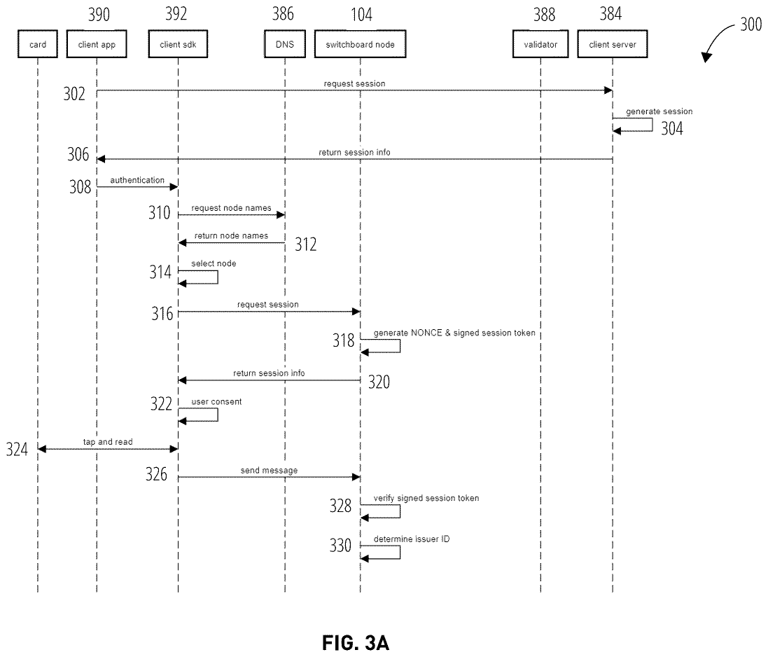

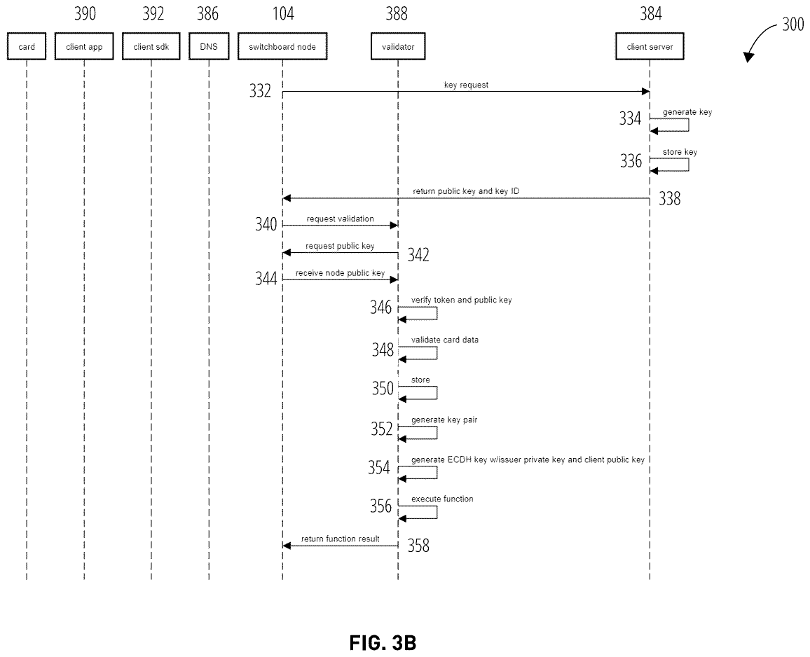

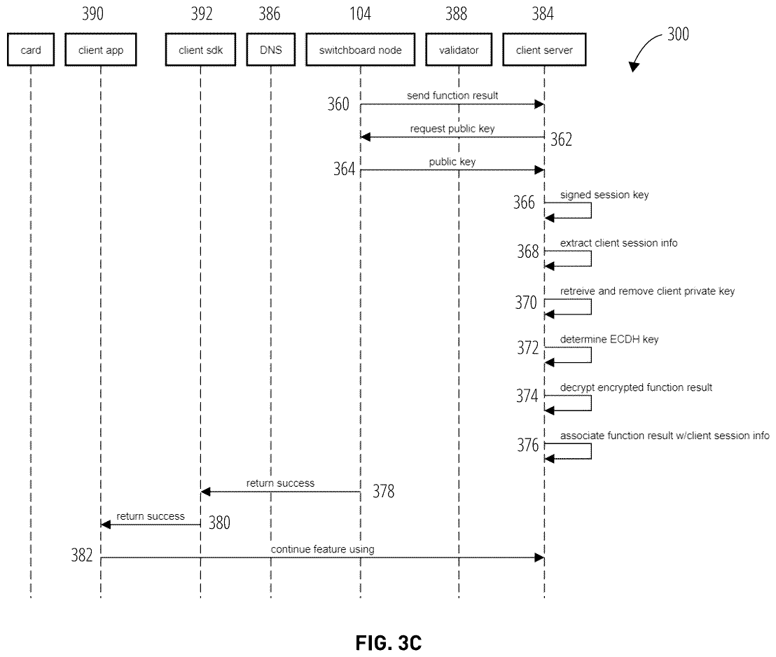

FIG. 3A-FIG. 3C illustrate an example of a sequence 300 to perform operations between a contactless card and services provided by a card issuer and/or a merchant. The illustrated sequence 300 includes actions and communications performed by the contactless card, a client including a client app 390 and a client sdk 392, a DNS 386, a switchboard system including one or more nodes, partner services including a merchant and/or validator 388, and control services including a client server 384 or system. In embodiments, the client app 390 may be any application configured to execute on a client, such as a banking app, a merchant app, a social media app, a travel app, a gaming app, a productivity app, an entertainment app, and so forth. In embodiments, the client app 390 includes a web browser to provide websites and pages. The client app 390 may include and/or utilize the client sdk 392, which may be a set of instructions that enable the client app 390 to communicate with other components of the switchboard system.

In embodiments, at 302 the client, including the client app, may send a request and establish a session with thr client server 384 such that a result may be associated with the correct client device or user. The request establishes a relationship between the client device and the client server 384, which may be an issuer server. At 304, the client server 384 generates a session and client session information. At 306, the client server 384 returns the client session information. In embodiments, the client session information may be client implementation-specific user session identification information.

At 308, the client app 390 may initiate a contactless card authentication process with the client sdk 392. For example, the client app 390 may call a function and/or pass information to the client sdk 392 to initiate authentication via the contactless card. At 310-314, the client may utilize the DNS to identify a node and establish communication with the node. Specifically, at 310, the client, including the client sdk 392, may send a request for switchboard hostnames, and at 312, the DNS 386 may return information including one or more hostnames. At 314, the client may determine a switchboard node with which to communicate. FIG. 2 illustrates an example of a more detailed sequence of the process to establish communication with the switchboard node.

At 316, the client may send a request a session with the switchboard node. In embodiments, the request for the session may be a function request in the format <FUNCTION REQUEST>. In embodiments, the function request may be data/function that the client would like to request once the contactless card has been validated. The function could be for any service discussed herein, e.g., authenticate the user, perform a transaction, request autofill data, etc. At 318, the switchboard node may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with the contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system private key. The switchboard system may include a NODE PUBLIC/PRIVATE KEY, which is a keypair used to sign and validate JWTs.

At 320, the switchboard node may return session information to the client. The session information may include a signed session token (<SIGNED SESSION TOKEN>), the NONCE <NONCE>, function terms of service <FUNCTION TOS>, and a terms of service version <TOS VERSION>. The FUNCTION TOS may be the terms of service that the user must consent to in order to allow the client to execute the requested function, and the TOS VERSION may be the version of the terms of service. At 322, the client sdk 392 may determine and/or receive user consent to the terms of service. In one example, the client sdk 392 captures and records user consent to <FUNCTION TOS> on <CONSENT DATE> with <TOS VERSION>. The CONSENT DATE may be the timestamp for the user's consent to the TOS.

At 324, the client exchanges one or more messages with the contactless card. In one example, the exchange may be based on the contactless card being tapped to the client device. In embodiments, the client sdk 392 may provide data to the contactless card to use during the session to perform the function. The data may be provided to the contactless card in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an NDEF message format example.

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary data - |
| | creation Time | represents 64 bit unix timestamp |
| 27 . . . 36 | Update MAC | MAC to protect control indicators - 16 bytes of ASCII |
| | | HEX encoded 8 bytes binary data |

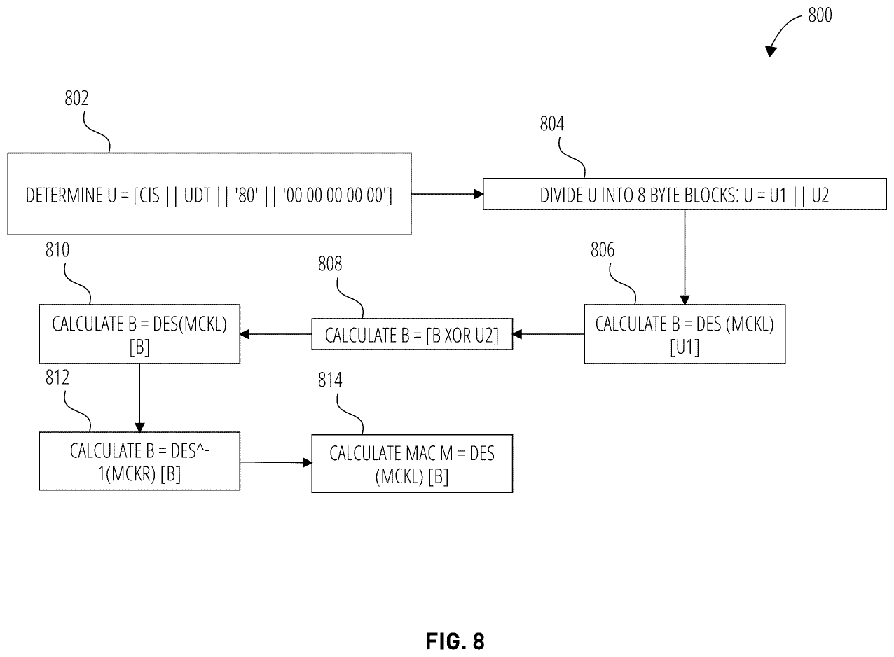

In embodiments, the updated message authentication code (MAC) may be calculated to protect the control indicators. Specifically, The MAC M is determined by calculating a MAC over the 10 bytes of the update data U with the Update MAC Card Key (MCK), as described in FIG. 8.

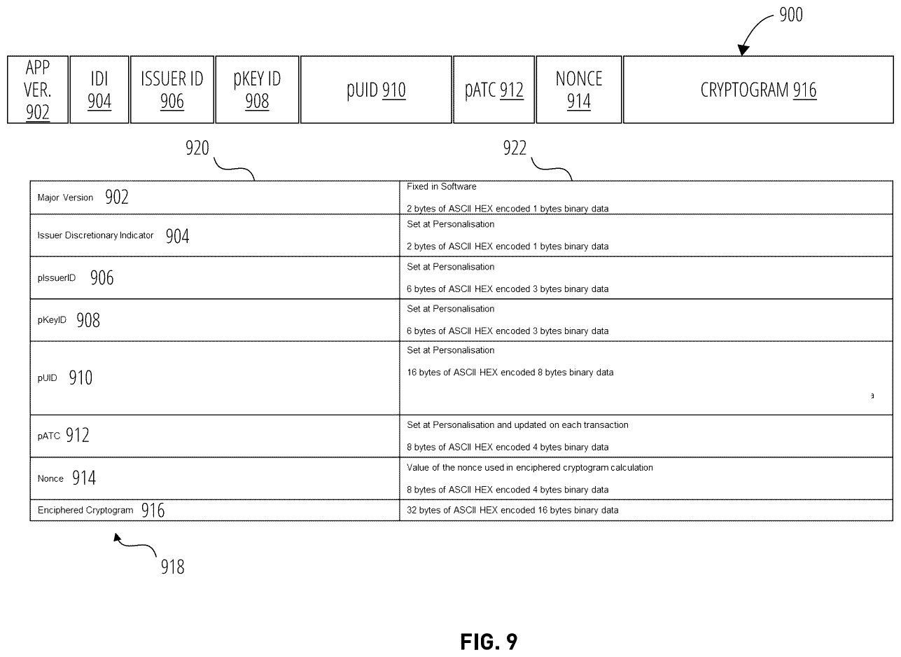

At 324, the contactless card may generate and provide a message to the client device including the client sdk 392. The data in the message may be utilized by the system discussed herein to perform the function requested. One example of the message is illustrated and discussed in FIG. 9.

At 326, the client, including the client sdk 392 may send a message and information to the switchboard node. The message may be the message received from the contactless card, e.g., message 900. In addition, the client sdk 392 may send the consent date, the TOS version, and the signed session token to the switchboard node. The switchboard node may utilize the information to ensure that the session is valid. At 328, the switchboard node verifies that the signed session token is valid, e.g., is the previously provided signed session token and includes the nonce previously generated in the message.

In some embodiments, the switchboard node is configured to determine which issuer system or client server it should route the message to for processing. At 330, the switchboard node may determine the issuer ID by extracting it from the message received from the contactless card via the client sdk 392. As mentioned, the issuer ID identifies the issuer of the contactless card.

In embodiments, the switchboard node is configured to generate and communicate secure communications with the issuer system, e.g., the client server 384 and the validator 388. At 332, the switchboard system 108 sends a request for a key to the client server 384. The key may be utilized to perform the secure communications. In one example, the key request may be an elliptical curve Diffie-Hellman (ECDH) key request. Embodiments are not limited in this manner and alternative key protocols may be utilized, e.g., Supersingular isogeny Diffie-Hellman key exchange (SIDH or SIKE), a private/public key pairing (RSA), etc.

At 334, the client server 384 generates a portion of the key. In some instances, the client server 384 may generate half of the ECDH key for encryption/decryption of PII. Specifically, the client server 384 may generate <CLIENT EC PUBLIC KEY> and <CLIENT EC PRIVATE KEY> using Elliptic Curve P256. The CLIENT EC PUBLIC KEY and CLIENT EC PRIVATE KEY is the first half of the ECDH key negotiation.

At 336, the client server 384 stores the generated portion of the key in a storage. Specifically, the client server 384 may store <CLIENT EC PUBLIC KEY> and <CLIENT EC PRIVATE KEY> with <KEY ID>, where the KEY ID is used by the client server 384 to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 384 may return the public key portion to the switchboard node with the KEY ID at 338. The switchboard node may store the public key portion with the KEY ID for later use, e.g., generation of the ECDH key. At 340, the switchboard system 108 may request a validation to be performed by the validator 388. In one example, the switchboard node may send a request validation as Request Validation <MESSAGE>, <SIGNED SESSION TOKEN>, <CLIENT EC PUBLIC KEY>, <CONSENT DATE>, and <TOS VERSION>. The validator 388 may make an out-of-band request back to the switchboard node for the public key to verify the session at 342. At 344, the switchboard node may provide the node's public key, i.e., <NODE PUBLIC KEY>. Further and at 346, the validator 388 may utilize the node's public key to verify the secure session token.

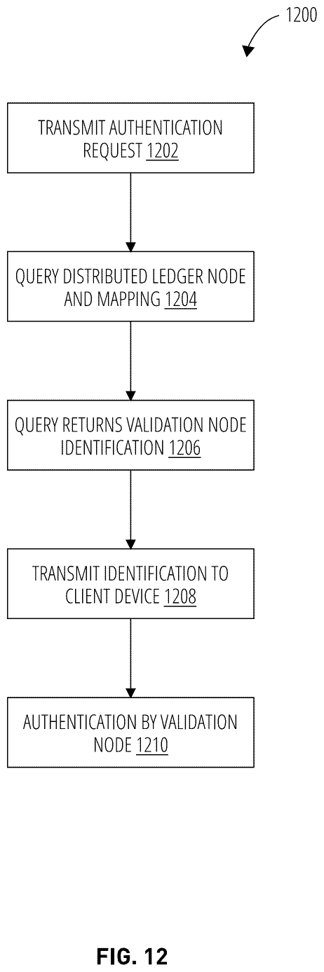

In embodiments, the validator 388 may validate the message at 348. In embodiments, the validator 388 may perform a number of validations including ensuring that the nonce in the message is correct along with additional information, such as the card's unique identifier (pUID), and a counter value (pATC). FIG. 12 discuss additional details of a validation process that may be performed.

At 350, the validator 388 may store information associated with the session. For example, the validator 388 may store <CONSENT DATE> with <TOS VERSION> and <PUID>. The validator 388 may also generate another portion of the key, e.g., the ECDH key. For example, the validator 388 may generate <ISSUER EC PUBLIC KEY> and <ISSUER EC PRIVATE KEY> using Elliptic Curve P256 at 352. The ISSUER EC PUBLIC KEY and ISSUER EC PRIVATE KEY may be the second half of the ECDH key negotiation.

At 354, the validator 388 may generate the complete ECDH key. For example, the validator 388 generate <ECDH KEY> from <ISSUER EC PRIVATE KEY> and <CLIENT EC PUBLIC KEY>. The ECDH KEY is the final key generated using ECDH key negotiation.

The validator 388 may utilize the ECDH KEY to encrypt data for the function. For example, and in some instances, if the validator 388 validates the message, the validator 388 may execute a function request to create a function result and encrypt the result with the ECDH KEY at 356. For example, the validator 388 may execute <FUNCTION REQUEST> to create <FUNCTION RESULT> and encrypt it with <ECDH KEY>. The function result may be any result based on the requested function, e.g., verification of the card.

At 358, the validator 388 may return the function result to the switchboard node. In some instances, the function result returned is encrypted. For example, the validator 388 may return <ENCRYPTED FUNCTION RESULT> and <ISSUER EC PUBLIC KEY>.

In embodiments, the switchboard node sends the function result to the client server 384 to process the result at 360. In one example, the switchboard node may send <ENCRYPTED FUNCTION RESULT>, <KEY ID>, <ISSUER EC PUBLIC KEY>, and <SIGNED SESSION TOKEN>. At 362 and 364, the client server 384 may make a request for and receive the public key from the switchboard node. In some instances, the exchange may be performed via out-of-band communication channels. The public key for the node may be <NODE PUBLIC KEY>. The public key may be used to verify the sender of the function result, etc. At 366, the client server 384 may verify the signed session key with the node's public key <NODE PUBLIC KEY> to verify the sender of the information. At 368, the client server 384 may extract client information from the signed session token. For example, the client server 384 may extract <CLIENT SESSION INFO> from <SIGNED SESSION TOKEN>, i.e., extracting the client implementation-specific user session identification information.

Further and at 370, the client server 384 may retrieve the client private key with the KEY ID. Specifically, the client server 384 may get and remove <CLIENT PRIVATE KEY> from a cache using <KEY ID>. At 372, the client server 384 may generate or compute the ECDH key. For example, the client server 384 may compute <ECDH KEY> with <CLIENT PRIVATE KEY>+<ISSUER EC PUBLIC KEY>. The client server 384 may decrypt the function result with the computed key at 374. Specifically, the client server 384 may decrypt <ENCRYPTED FUNCTION RESULT> with <ECDH KEY> to determine <FUNCTION RESULT>. At 376, the client server 384 associates the function result with the session.

In embodiments, the switchboard node may return that the function result was successfully completed or not at 378 to the client sdk 392. Further and at 380, the client sdk 392 may notify the client app 390 of the result. At 382, the client app 390 may utilize the feature. For example, the client app 390 may communicate with the client server 384 to continue the feature using <CLIENT SESSION INFO> to fetch a redacted <FUNCTION RESULT>.

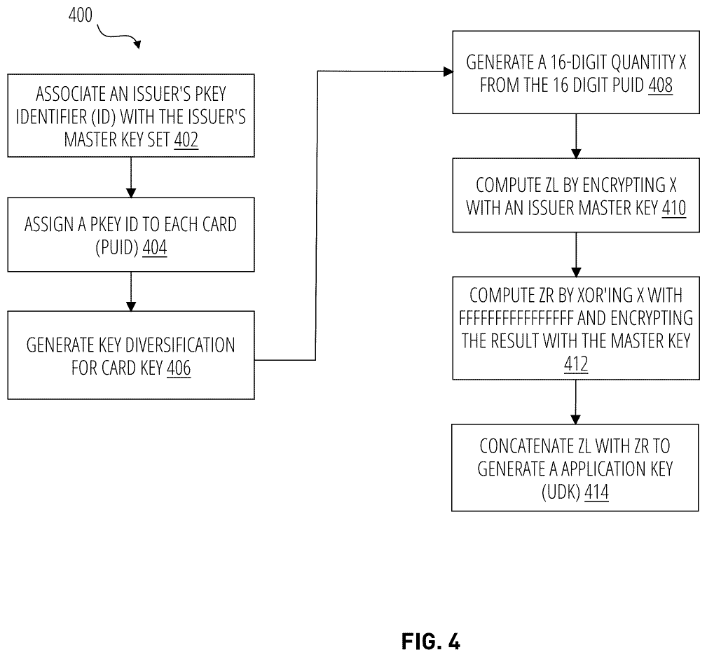

FIG. 4 illustrates an example of a flow 400, which is an example of operations to identify the issuer's master keys and generate unique card master keys or application keys. In some instances, these operations may be performed off the card, at personalization time, and then stored in a memory of the card. Further, the issuer's master key(s) may be utilized to generate card master keys. The card master keys may be known as application keys or unique derived keys (UDKs). Each contactless card may have one or more UDKs.

In embodiments, each contactless card includes one or more applications, such as an authentication application, that is given a unique 16-digit identity (pUID) at a time of personalization. Each contactless card may also receive application keys, which may also be known as UDKs or card master keys using the pUID. In some instances, these operations are performed off-card, and the resultant keys are injected during personalization. However, in other instances, one or more of these operations may be performed on card, e.g., at the time of manufacturer, each time an operation is performed with a key, and so forth.

At block 402, embodiments include a system configured to generate a number of issuer master key setting and assigning each unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the operations discussed in blocks block 404 to block 414.

At block 404, the system assigns a pKey ID to a card or a pUID, a card application's unique 16-decimal digital identify. At block 406, the system initiates generating a card's UDK(s). At block 408, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit X may be utilized to generate one or more UDKs.

At block 410, the system computes or calculates ZL by encrypting X with an issuer master key. An encryption algorithm, such as DES or a DES variant, may be utilized in embodiments. Embodiments are not limited in this manner, and other examples of encryption algorithms include AES and public-key algorithms, such as (RSA).

At block 412, the system calculates or computes ZR by XOR'ing X with FFFFFFFFFFFFFFFF and encrypting the result with an issuer master key. Again, an encryption algorithm such as DES, AES, RSA, etc., may be used to encrypt the result of the XOR'ing. At block 414, the system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys.

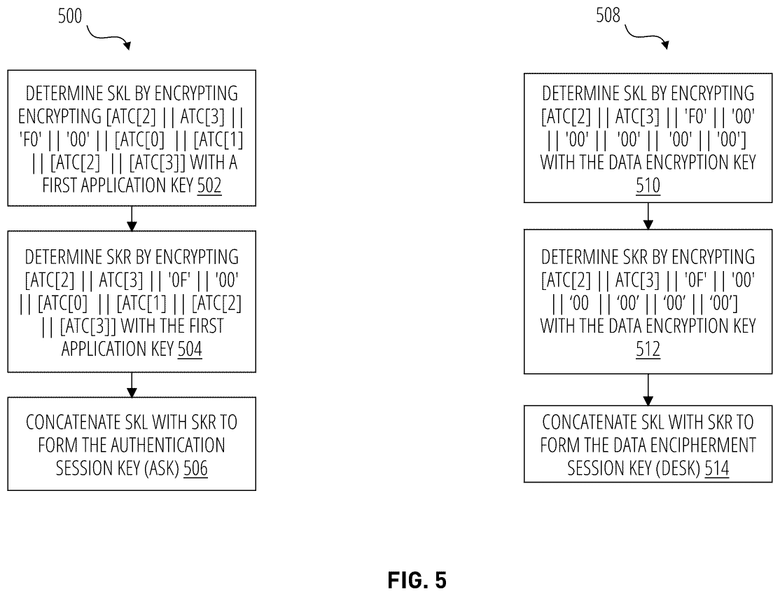

FIG. 5 illustrates an example of a first flow 500 to generate a unique authentication session key (ASK) and an example of a second flow 508 to generate a unique data encipherment session key (DESK) in accordance embodiments. The operations discussed in connection with the flow 500 and the flow 508 may be performed on the contactless card.

At block 502, the contactless card, including circuitry, computes SKL by encrypting [ATC[2]∥ATC[3]∥‘F0’∥‘00’∥[ATC[0]∥[ATC[1]∥[ATC[2]∥[ATC[3]] with an application key, e.g., the key generated in the flow 400. Further, at block 504 the contactless card computes SKR by encrypting [ATC[2]∥ATC[3]∥‘0F’∥‘00’∥[ATC[0]∥[ATC[1]∥[ATC[2]∥[ATC[3]] with the application key. Finally and at block 506, the contactless card concatenates SKL with SKR to form an ASK. In embodiments, the ASK is used to perform operations utilizing the contactless card, such as encrypting a cryptographic MAC.

In embodiments, a card applet also supports session key derivation to generate the DESK as shown in the flow 508. At block 510, the contactless card, including circuitry, computes SKL by encrypting [ATC[2]∥ATC[3]∥‘F’∥00′∥‘0’∥‘00’∥‘00’∥‘00’] with a data encryption key (DEK). Further and at block 512, the contactless card computes SKR by encrypting [ATC[2]∥ATC[3]∥‘0F’∥‘00’∥‘00’|‘00’∥‘00’∥‘00’] with the DEK. At block 514, the contactless card concatenates SKL with SKR to form the data encipherment session key.

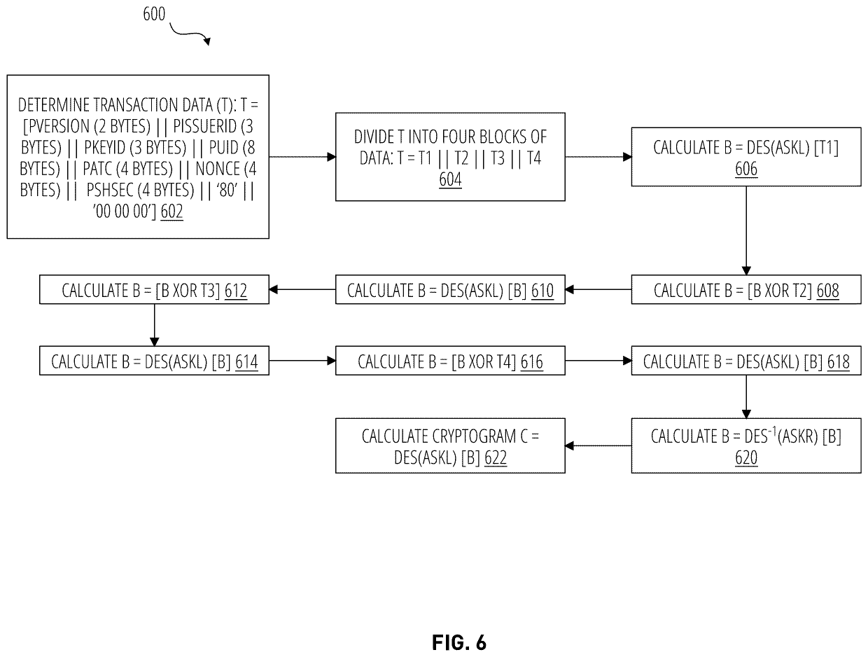

FIG. 6 illustrates an example a flow 600 that may be performed by a contactless card or circuitry thereon to generate a cryptogram to perform operations discussed herein, e.g., see FIG. 9. A cryptogram C is determined by calculating the MAC over 32-byte transaction data T using the ASK generated as described in connection with the flow 500 in FIG. 5.

At block 602, the contactless card, including circuitry, computes T=[pVersion (2 bytes)∥pIssuerID (3 bytes)∥pKeyID (3 bytes)∥pUID (8 bytes)∥pATC (4 bytes)∥nonce (4 bytes)∥pSHSEC (4 bytes)∥‘80’∥‘00 00 00’]. In one example, the pVersion is an applet version number, the pIssuerID is an issuer identifier, the pKeyID includes data that identifies a set of master keys for a card issuer of the contactless card, the pUID is a card unique identifier assigned to the contactless card, the pATC is a card's counter value, the nonce is the nonce provided during communication with another device as described herein, and the pSHSEC is a value to indicate adherence to Secure Hardware Security Evaluation Criteria.

The contactless card may process the data to generate the cryptogram. At block 604, the contactless card divides T into four blocks of 8 bytes of data: T=T1∥T2∥T3∥T4. At block 606, the contactless card computes B=DES(ASKL) [T1], where DES is the Data Encryption Standard or another symmetric encryption algorithm and ASKL is a portion of the ASK, e.g., the “left” half of the key. At block 608, the contactless card computes B=[B XOR T2], and at block 610, the contactless card computes B=DES(ASKL) [B], where DES is the encryption algorithm. At block 612, the contactless card computes B=[B XOR T3], and at block 614, the contactless card computes B=DES(ASKL) [B]. At block 616, the contactless card computes B=[B XOR T4] and at block 618 the contactless card computes B=DES(ASKL) [B]. At block 620, the contactless card compute B=DES⁻¹(ASKR) [B], where DES⁻¹ is the reciprocal DES operation and ASKR is a portion of the ASK, e.g., the right half. At block 622, the contactless card computes the cryptogram C=DES(ASKL) [B].

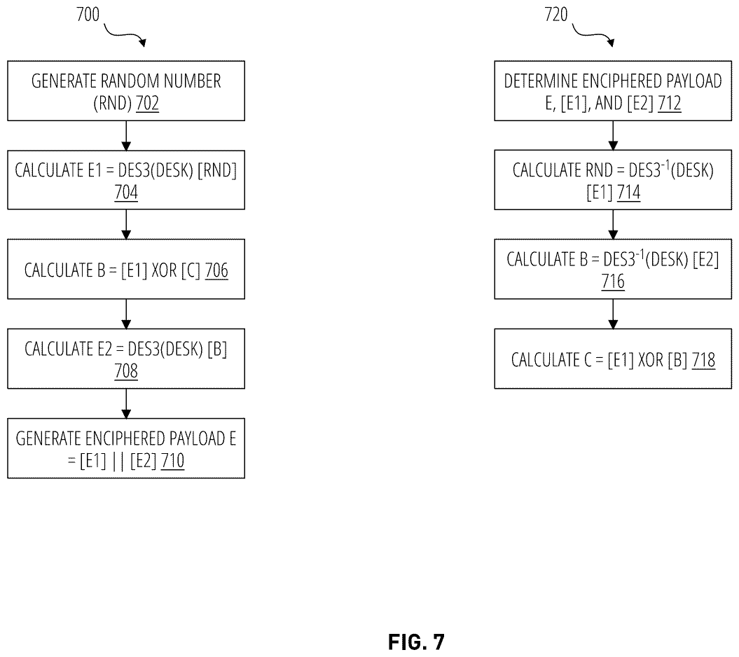

In embodiments, a contactless card may encipher the cryptogram to secure the data further. FIG. 7 illustrates an example of a first flow 700 to encipher the cryptogram with the DESK as described in connection with the flow 500 of FIG. 5 being used to encrypt in Cipher Block Chaining (CBC) mode, and an example of a second flow 720 to decrypt a payload.

At block 702, a contactless card, including, circuitry is configured to generate an 8-byte random number [RND]. At block 704, the contactless card computes E1=DES3(DESK) [RND], where DES3 is a symmetric encryption algorithm such as the Triple DES. At block 706, the contactless card computes B=[E1] XOR [C], where C is the cryptogram generated in the flow 600 of FIG. 6. The contactless card computes E2=DES3(DESK) [B] at block 708, where B is computed as in the flow 600 of FIG. 6. At block 710 the contactless card generates the 16 byte enciphered payload E=[E1]∥[E2].

In embodiments, a device or the contactless card my decrypt the payload E in accordance with the flow 720. At block 712, the device determines or retrieves the payload E. At block 714, the device computes a RND=DES3⁻¹ (DESK) [E1]. At block 716, the device determines B=DES3⁻¹ (DESK) [E2], and at block 718, the device computes C=[E1] XOR [B].

FIG. 8 illustrates an example of a flow 800 for calculating the MAC. In some embodiments, operations of the flow 800 can be executed by circuitry of a contactless card. In some instances, the MAC may be an updated MAC. In embodiments, the updated MAC is included in data communicated from the contactless card to another device, such as a mobile device, point-of-sale (POS) terminal, or any other type of computer. In one example, the updated MAC may be included in an NDEF message.

In embodiments, the updated MAC may be calculated to protect control indicators and include an updated date/time. For example, the updated MAC M is determined by calculating a MAC over 10 bytes of update data U with an Update MAC Card Key (MCK) as follows.

At block 802, embodiments include determining data to process through a number of calculations and computations. In one example, the update data U equals [Control Indicators (2 bytes)∥Update Date Time (8 bytes)∥‘80’∥‘00 00 00 00 00’]. For the calculations, the data may be divided into two separate portions. Specifically, at block 804, the update data U is broken into two blocks of 8 bytes of data, where U=U₁∥U₂. Further, the operations may be performed on U₁ and U₂.

At block 806, embodiments include applying an algorithm to the first portion (U₁) of the data. In one example, a result B may be computed where B=DES(MCKL) [U1], where the DES is algorithm uses a first portion (L) of a MAC Card Key (MCKL).

At block 808, an additional operation may be performed on the result B. Specifically, the result B may be exclusively or'd (XOR) with a second portion of the data (U₂).

The updated result B may be further processed at block 810. For example, result B may be further processed by applying the DES algorithm using MCKL again to B. The result B of block 810 may further be processed at block 812. Specifically, the result B may be processed by the inverse DES with a second portion (R) of the MCK (MCKR). At block 814, the MAC M may be determined by applying the DES algorithm with the MCKL to result B of block 812.

FIG. 9 illustrates an example of a message 900 that may be communicated by a contactless card to perform the functions described herein. One or more fields in the message 900 may also be utilized to route the message 900 through a switchboard system and perform authentication/validation techniques.

In embodiments, the message 900 includes an applet version 902 field, an issuer discretionary indicator 904 field, an issuer identifier 906 field, a pKey ID 908 field, a pUID 910 field, a pATC 912 field, a nonce 914 field, and an encrypted cryptogram 916.

In embodiments, the fields may be in plain text or encrypted. For example, the applet version 902 field may include an applet version in plain text. The applet version can indicate which applet version is installed on the contactless card and may be used by other systems to determine how to process the message 900 when communicated. For example, different applet versions require different validation logic, e.g., an older message may be routed through the issuer system to perform various operations for validation, while a newer message may be routed through the switchboard system to perform the various operations, including validation.

In embodiments, the issuer discretionary indicator 904 field may include issuer data and be set at the time of personalization. In addition, the issuer identifier 906 field may include a unique ID assigned to the entity issuing the card, e.g., the issuer. For example, each issuer may be assigned a unique identifier during an onboarding operation when joining the system. The issuer ID can be used by the switchboard system to route the message 900 and its contents to the appropriate services that are associated with that particular issuer.

In embodiments, the pKey ID 908 field may include data that identifies a set of master keys for a card issuer. The issuer's set of master keys may utilize each card's set of derived master keys or UDKs. Further, each card's own set of master keys (UDKs) may be generated during the personalization of the card. The card's UDKs may be utilized to generate session keys that are used to generate an application cryptogram. The session keys generated by a card may be regenerated by a system, e.g., the validator system, utilizing the pKeyID to identify the issuer's masters keys to regenerate session keys by the system to perform validation.

In embodiments, each contactless card is given a unique 16-decimal digit identity (pUID) at the time of personalization. Derivation of the card applet's unique keys using the pUID is performed off-card. The resultant application keys are injected during the personalization of the card. In embodiments, a card's application keys are the same as the card's derived master keys or UDKs. The process for deriving the application keys (UDKs) is described in the flow 400 of FIG. 4.

The pUID 910 field may include a card unique identifier assigned to the contactless card at personalization time. The pUID 910 field data may be a combination of alphanumeric characters used to uniquely identify each card and associated with a user.

In embodiments, the pATC 912 field may be configured to hold a counter value. The counter value keeps a count of reads (taps) made on the contactless card in a hexadecimal format in one example. Further, the counter value may be used to generate session keys to encrypt at least a portion of a message.

In embodiments, each time the message 900 is created, a new session key is derived and utilized to generate one or more portions of the message 900. Specifically, a session key is used to calculate the cryptographic MAC (application cryptogram). The card's applet supports a session key derivation option to generate a unique cryptogram session key ASK as described in the flow 500 of FIG. 5 and a unique DESK as described in the flow 508 of FIG. 5. The generation of the cryptogram is discussed in the flow 600 of FIG. 6 and the flow 700 of FIG. 7. Further, the cryptogram may decrypted in accordance with the flow 720 of FIG. 7.

In embodiments, a portion of the data provided in the message 900 is static and set on the card during the personalization of the card and other data is dynamic and may be generated by the card during an operation, e.g., when a read operation is being performed. In some instances, the static information may be updateable, but may require the customer and card to go through a secure update process, which may be controlled by the issuer.

In embodiments, the contactless card may communicate the message 900 to a device, such as a mobile device, during a read operation. For example, in response to the contactless card being tapped onto a surface of the device, e.g., brought within a wireless communication range, a read operation may be performed on the contactless card, and the contactless card may generate and provide the message 900 to the device. For example, once within range, the contactless card and the device may perform one or more exchanges for the contactless card to send the message to the device. 324 in FIG. 3A illustrates one example of such an exchange.

The wireless communication may be in accordance with a wireless protocol, such as NFC, Bluetooth, WiFi, and the like. In some instances, the message 900 may be communicated between the contactless card and the device via wired means, e.g., via a contact pad, and in accordance with the EMV protocol.

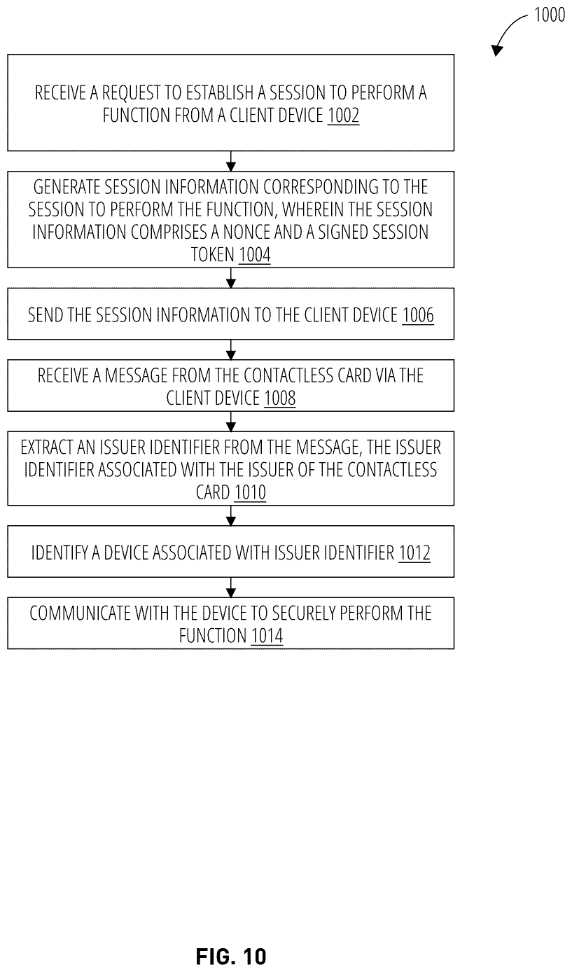

FIG. 10 illustrates an example of routine 1000 in accordance with embodiments discussed herein. In block 1002, the routine 1000 includes receiving, by a node in a system, a request to establish a session to perform a function from a client device, wherein the function is at least partially performed utilizing a contactless card. In some instances, the node may be one of a plurality nodes of a switchboard system. The node may be previously selected by the sending device via a DNS operation performed.

In block 1004, the routine 1000 includes generating, by the node, session information corresponding to the session to perform the function, wherein the session information comprises a nonce and a signed session token. The nonce and/or signed session token may be utilized by systems to perform the functions described herein while ensuring the node routing the data is authenticate, the message from the contactless card is authenticate, and to keep track of the session for the function.

In block 1006, routine 1000 includes sending, by the node, the session information to the client device. The client device may communicate with a contactless card to receive data from the card to authenticate and perform a function. In some instances, the client device may send the nonce from the node to the contactless card. The contactless card may utilize the nonce when generating the message to communicate back to the client device and finally, the node, e.g., incorporates it into a cryptographic portion of the message (see FIG. 9).

In block 1008, routine 1000 includes receiving, by the node, a message from the contactless card via the client device. The message may be generated by the contactless card. FIG. 9 illustrates one example of a message 900. In some embodiments, the node verifies the message. For example, the node may verify a nonce in the message and a signed session token.

In block 1010, routine 1000 extracts, by the node, an issuer identifier from the message, the issuer identifier associated with the issuer of the contactless card. In some instances, the issuer identifier may be in a plaintext format.

In block 1012, routine 1000 identifies, by the node, a device associated with the issuer identifier. For example, the node may perform a lookup to determine a server associated with the issuer identifier and the function to be performed.

In block 1014, routine 1000 communicates, by the node, with the device to securely perform the function.

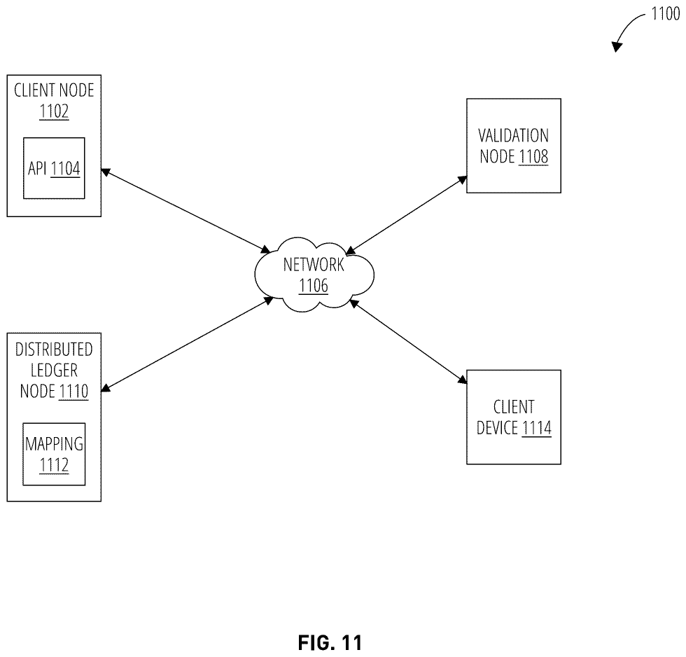

FIG. 11 illustrates an example of a distributed network authentication system 1100 in accordance with embodiments discussed herein. As further discussed below, the system 1100 can include a client node 1102, an API 1104, a network 1106, a distributed ledger node 1110, mapping 1112, and a client device 1114. Although FIG. 11 illustrates single instances of these components, the system 1100 can include any number of components.

The client node 1102 can be a network-enabled computer as described herein. In some examples, the client node 1102 can be a server, which can be a dedicated server computer or a bladed server, or can be a personal computer, a laptop computer, a notebook computer, a palm top computer, a network computer, a mobile device, a wearable device, or any processor-controlled device capable of supporting the system 1100.

In some examples, the client node 1102 can execute one or more applications, such as software applications, that enable, for example, network communications with one or more components of the system 1100. The client node 1102 can transmit and/or receive data and perform the functions and processes described herein.

The client node 1102 can contain the API 1104. For example, various different APIs can be provided for an application (e.g., executed on a computing device, such as a network-enabled computer) that can interact with a service. For example, an application executed on a device (e.g., a smart phone, smart watch, tablet, laptop, or other device) can interact with a web-based service by calling the API 1104 to interact with the service, such as by performing a remote call to the API 1104 for interacting with a web-based service.

The API 1104 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

The client node 1102 can communicate with one or more other components of the system 1100 either directly or via the network 1106. The network 1106 can comprise one or more of a wireless network, a wired network or any combination of a wireless network and a wired network, and may be configured to connect the components of the system 1100. While FIG. 11 illustrates communication between the components of system 1100 through the network 1106, it is understood that any component of the system 1100 can communicate directly with another component of the system 1100, e.g., without involving the network 1106.

The system 1100 can include a validation node 1108, which can be a network-enabled computer as described herein. In some examples, the validation node 1108 can be a server, which can be a dedicated server computer or a bladed server, or can be a personal computer, a laptop computer, a notebook computer, a palm top computer, a network computer, a mobile device, a wearable device, or any processor-controlled device capable of supporting the system 1100.

In some examples, the validation node 1108 can execute one or more applications, such as software applications, that enable, for example, network communications with one or more components of the system 1100. The validation node 1108 can transmit and/or receive data and perform the functions and processes described herein.

In some examples, the validation node 1108 can be associated with a routing number, and the routing number can identify an entity controlling keys for an authentication namespace. The authentication namespace can be related to one or more of a particular entity, a particular set of cards, or a particular set of security keys (e.g., master keys, diversified keys, session keys) associated with the entity, a set of cards, or a type of cards.

The distributed ledger node 1110 can be a network-enabled computer as described herein. In some examples, the distributed ledger node 1110 can be a server, which can be a dedicated server computer or a bladed server, or can be a personal computer, a laptop computer, a notebook computer, a palm top computer, a network computer, a mobile device, a wearable device, or any processor-controlled device capable of supporting the system 1100.

In some examples, the distributed ledger node 1110 can execute one or more applications, such as software applications, that enable, for example, network communications with one or more components of system 1100. The distributed ledger node 1110 can transmit and/or receive data and perform the functions and processes described herein.

The distributed ledger node 1110 can include the mapping 1112. In some examples, the mapping 1112 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of the system 1100, or the one or more databases can be hosted externally to any component of the system 1100. In some examples, the one or more databases can be contained in the distributed ledger node 1110, and in other examples, the one or more databases can be stored outside of the distributed ledger node 1110 but in data communication with the distributed ledger node 1110. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within the distributed ledger node 1110. In other examples, the one or more databases can be remote from the distributed ledger node 1110 but in data communication with the distributed ledger node 1110. Data communication between the one or more databases and the distributed ledger node 1110 can be a direct data communication or data communication via a network, such as the network 1106.

In some examples, the client node 1102 can be in data communication with the distributed ledger node 1110. The distributed ledger node 1110 can contain the mapping 1112. The mapping 1112 may include, for example, a mapping between a validation node address and the validation node 1108, a mapping between a routing number and a validation node address, and/or a mapping between a routing number and the validation node 1108. In some examples, the mapping 1112 can include a digital signature associated with an entity having permission to validate for a routing number. Based on one or more of these associations, the client node 1102 can call the validation node 1108 for validation and/or provide direction to the client device 1114 to reach an appropriate validation node. This can be accomplished by calling a validation API associated with the validation node 1108.

In some examples, iterations of the mappings described herein, such as the mapping 1112, can also include a software or applet version number. The version number can be used to identify a validation node or validation node address or choose between multiple validation addresses for one validation node.

In some examples, the client node 1102 and the distributed ledger node 1110 can be permissioned (e.g., allowed to join a network) with the aid of a certificate and/or a cryptographic authentication mechanism (e.g., a non-fungible token). The certificate and/or a cryptographic authentication mechanism may be issued by, for example, a consortium authority or other administrative entity associated with the network. If granted appropriate permissions, the distributed ledger node 1110 can update the mapping 1112 to reflect a different association between, for example, a routing number, a validation node address, and a validation node. In some examples, degrees of permissions can be issued. For example, if the client node 1102 were to function to route data to the validation node 1108 (or other validation nodes), then the client node 1102 can be given a certain level of permissions. As another example, if the distributed ledger node 1110 were to have the capability to update the mapping 1112, then the distributed ledger node 1110 can have a different, higher level of permissions.

The client device 1114 can be a network-enabled computer as described herein. In some examples, the client device 1114 can be a server, which can be a dedicated server computer or a bladed server or can be a personal computer, a laptop computer, a notebook computer, a palm top computer, a network computer, a mobile device, a wearable device, or any processor-controlled device capable of supporting the system 1100. As described, the client device 1114 may also be a mobile device. For example, the mobile device may include an iPhone, iPod, or iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, the client device 1114 can be in data communication with another network-enabled computer not shown in FIG. 11, such as a smart card (e.g., a contactless card or a contact-based card).

In some examples, the client device 1114 can execute one or more applications, such as software applications, that enable, for example, network communications with one or more components of the system 1100. The client device 1114 can transmit and/or receive data and perform the functions and processes described herein.

In some examples, upon receipt of an authentication request, the client device 1114 can call (e.g., via an API) the client node 1102. Such a call can include a routing number and/or an applet or software version number, and the client node 1102 can query the distributed ledger node 1110 and the mapping 1112. Once such a query returns an identification of a validation node (e.g., the validation node 1108) and/or a validation node address associated with that routing number and/or applet or software version, the client node 1102 can reply to the client device 1114. The client device 1114 can then proceed with authentication with the validation node 1108. This authentication can be performed by, for example, the systems and methods described herein, such as by the generation, encryption, transmission, decryption, and validation of a cryptogram as described herein.

In some examples, the client node 1102 can be co-resident with the validation node 1108. In these examples, the client node 1102 can handleauthentication in a single call from the client device 1114. In some examples, this can be acceptable only if it is permissible for the full authentication transmission (e.g., a cryptogram as described herein) to be sent to client nodes that are not involved in authentication.

In some examples, if the client node 1102 receives, from the client device 1114, a routing number that is not handled by its location, then the client node 1102 can return a code indicating that this routing number is not handled, along with a validation node address for the responsible validation node. Then, the client device 1114 can send the full authentication transmission to the validation node 1108 using the received validation node address.

In some examples, the client node 1102 can enter a distributed network with different permissions. For example, the client node 1102 can be a read-only router of data. As another example, the client node 1102 can have permission to send messages to the distributed ledger node 1110 for updating one or more routing paths for one or more routing numbers. However, the client node 1102 could be prevented from updating one or more routing paths for one or more routing numbers for other entities that control other routing numbers which are not associated with the client node 1102 or that did not grant this permission. As another example, the distributed ledger node 1110 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and revoke any of the foregoing. In some examples, the foregoing permissions can be delegated to the client node 1102, the distributed ledger node 1110, and/or the validation node 1108, if security, legal, and/or financial conditions are met, however, delegation is not required.

In some examples, one or more APIs can facilitate communication between components of the system 1100 via the network 1106. In other examples, one or more APIs are not required. Rather, the components of the system 1100 could be in direct communication and/or dedicated to one or more specified entities to allow these specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by the validation node 1108 for authentication, can require storage of those keys in one or more HSMs to promote key security and ensure that those keys are never entered into memory.

FIG. 12 illustrates an example of a method 1200 performed by a distributed network authentication system in accordance with embodiments discussed herein. For example, the method routine 1200 can be performed by the distributed network authentication system 1100 and/or by another distributed network authentication system.

In block 1202, a client device can transmit an authentication request to a client node. The authentication request can include, without limitation, a routing number, a software version number, and/or an applet version number. The request can be made by an API call or other communication between the client device and the client node.

In block 1204, after receiving the authentication request, the client node can transmit a query (e.g., via an API call) to a distributed ledger node. The distributed ledger node can contain mapping, and the distributed ledger node can submit the query to the mapping.

In block 1206, the query can return an identification of a validation node and/or a validation node address, and the distributed ledger node can transmit this identification to the client node.

In block 1208, the client node can transmit the identification to the client device. After receiving the identification, the client device can proceed with authentication with the validation node and/or the validation node address identified in block 1210.

FIGS. 1-12 are generally directed to systems and methods to authenticate a contactless card based on information on the contactless card. However, as previously discussed, some embodiments disclosed herein can include systems and methods for unlocking a user experience, for example, by dynamically redirecting a URL embedded on the contactless card to unlock the user experience most likely desired by a customer associated with the contactless card.

In accordance with disclosed embodiments, when a user wants to initiate, execute, or complete a transaction on a mobile device in connection with the contactless card, the user can tap or otherwise bring the contactless card into a communications range of a short-range communication antenna of the mobile device for NFC. The contactless card can transmit to the mobile device and/or the mobile device can receive from the contactless card encrypted data, for example, encrypted using systems and methods described herein in connection with FIGS. 1-12, and systems and methods disclosed herein can successfully decrypt the encrypted data to authenticate the contactless card, for example, decrypted using systems and methods described herein in connection with FIGS. 1-12.

In some embodiments, the contactless card can also transmit to the mobile device and/or the mobile device can also receive from the contactless card a user ID. In some embodiments, the user ID can be part of the encrypted data, and in any embodiment, the encrypted data can be embedded in or encoded on an applet on the contactless card.

Still further, the contactless card can transmit to the mobile device and/or the mobile device can receive from the contactless card the URL. As above, the URL can be embedded in or encoded on the applet of the contactless card.

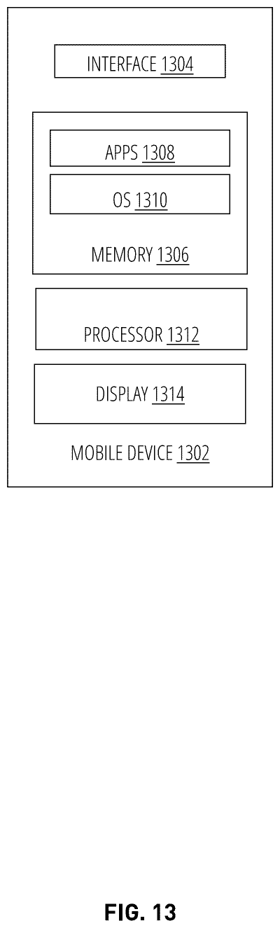

Using machine learning, systems and methods disclosed herein can determine one or more functions most likely desired by the user and dynamically redirect the URL to a website, for example, loaded on a mobile browser of the mobile device, or a mobile application on the mobile device for performing those functions. Accordingly, the user can click on a link to access the website or the mobile application on the mobile device and/or the website or the mobile application can enable the user to click therein or thereon to initiate, execute, and/or complete the transaction. FIGS. 13-20 are generally directed to these embodiments and provide additional details thereof.

While embodiments disclosed herein are described in connection with with the contactless card and the mobile device, embodiments disclosed are not so limited. Instead, embodiments disclosed herein can also include the user tapping or otherwise bringing the contactless card into a communications range of a short-range communication antenna of a desktop computer, a laptop computer, a tablet computer, or the like. As such, the contactless card can transmit to the desktop computer, the laptop computer, or the tablet computer and/or the desktop computer, the laptop computer, or the tablet computer can receive from the contactless card the encrypted data and the URL. When systems and methods disclosed herein determine the one or more functions most likely desired by the user, systems and methods disclosed herein can dynamically redirect the URL to a website on a browser of the desktop computer, the laptop computer, or the tablet computer. In these embodiments, an operating system of the desktop computer, the laptop computer, or the tablet can include functions to support NFC between the contactless card and the desktop computer, the laptop computer, the tablet computer and/or browsers thereof via WebNFC®.

FIG. 13 is a block diagram that illustrates an example of a mobile device 1302 in accordance with disclosed embodiments. It is to be understood that the mobile device 1302 can be the same as or similar to the client device 1114.

As seen, the mobile device 1302 can include an interface 1304, a memory 1306, a processor 1312, and a display device 1314. The memory 1306 can be configured to store computer instructions configured to be executed by the processor 1312 to cause the processor 1312 to execute certain actions, and the computer instructions can be part of applications 1308 and/or an operating system 1310.

In some embodiments, the interface 1304 can include one or more antennas, such as a short-range communication antenna, one or more user interface devices, such as a key pad with hard or soft keys, and/or a camera, a microphone, a scanner, a card reader, or another device capable of reading or capturing images, information, or data within its range or field of view. Additionally or alternatively, the interface 1304 can include a WiFi interface, a Bluetooth interface, an NFC interface, a serial bus interface, a universal serial bus (USB), and so forth.

In some embodiments, the memory 1306 can be any type of memory configured to store instructions to be processed by the processor 1312. Examples of the memory 1306 can include volatile or non-volatile memory, removable or non-removable memory, erasable or non-erasable memory, writeable or re-writeable memory, and so forth.

In some embodiments, the processor 1312 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

In some embodiments, the display device 1314 can include a display screen or other output device for displaying data, information, and/or graphics to a user of the mobile device 1302.

The memory 1306 can include the applications 1308 and/or the operating system 1310. In this regard, the applications 1308 can include any type of application configured to operate on the mobile device 1302. For example, the applications 1308 can include mobile banking applications, mobile credit card applications, business applications, social networking applications, marketplace applications, classifieds applications, communication applications, business productivity applications (e.g., email, word processor, spreadsheet, etc.), storefront applications, money transfer applications, gaming applications, merchant applications, shopping mobile applications, and so forth.

The applications 1308 can be configured to operate within the operating system 1310. In some embodiments, the operating system 1310 can be an Android® operating system, Apple iOS® operating system, Windows Mobile Operating System®, and so forth. The operating system 1310 can be configured to provide services and instructions that execute and enable the applications 1308 to operate with hardware. For example, the operating system 1310 can be configured to operate with the hardware associated with the processor 1312 to process detections made by the interface 1304 and/or to transmit corresponding signals and data via the interface 1304. In some embodiments, the operating system 1310 can provide data to the applications 1308 processed by the operating system 1310. The applications 1308 can process such data, including performing authentications of the data, communicating the data to other devices or servers, and so forth. In some embodiments, at least a portion of the operating system 1310 can be configured to perform one or more authentication steps.

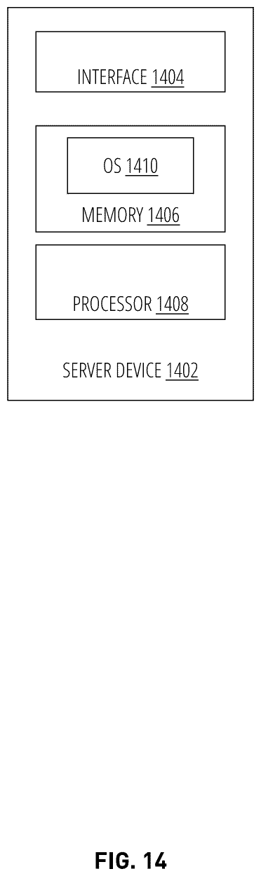

FIG. 14 is a block diagram that illustrates an example of a server device 1402 in accordance with disclosed embodiments. It is to be understood that the server device 1402 can be the same as or similar to the client node 1102, the validation node 1108, and/or the distributed ledger node 1110.

As seen, the server device 1402 can include an interface 1404, a memory 1406, and a processor 1408. The memory 1406 can be configured to store computer instructions configured to be executed by the processor 1408 to cause the processor 1408 to execute certain actions. The computer instructions can be part of an operating system 1410.

In some embodiments, the interface 1404 can be wired or wireless. For example, the interface 1404 can include a WiFi interface, a Bluetooth interface, an NFC interface, a serial bus interface, a universal serial bus (USB), and so forth.

In some embodiments, the memory 1406 can be any type of memory configured to store instructions to be processed by the processor 1408. Examples of the memory 1406 can include volatile or non-volatile memory, removable or non-removable memory, erasable or non-erasable memory, writeable or re-writeable memory, and so forth.

In some embodiments, the processor 1408 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

As explained above, the memory 1406 can include the operating system 1410. In some embodiments, the operating system 1410 can include a Microsoft Windows server operating system, a Linux/Unix server operating system, a cloud server operating system, such as an Amazon AWS operating system, and so forth. The operating system 1410 can be configured to provide services and instructions that execute to operate with hardware. For example, the operating system 1410 can be configured to operate with the hardware associated with the processor 1408 to process signals and data received by the interface 1404, including performing authentication of such data. In some embodiments, at least a portion of the operating system 1410 can be configured to perform one or more authentication steps.

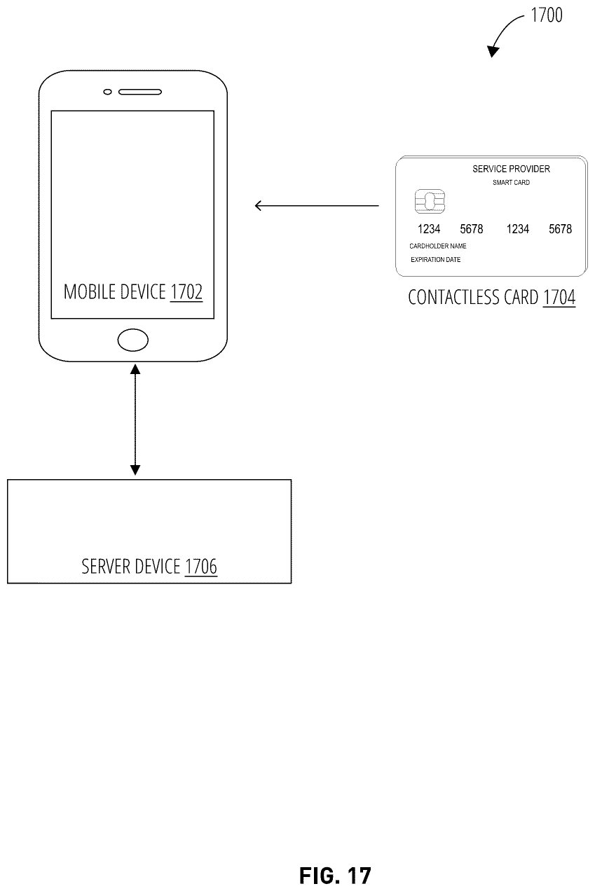

FIG. 17 is a block diagram that illustrates an example of a system 1700 in accordance with disclosed embodiments. As seen, the system 1700 can include at least a mobile device 1702, a contactless card 1704, and a server device 1706 in communication with the mobile device 1702. It is to be understood that the mobile device 1702 can be the same as or similar to the mobile device 1302 and/or the client device 1114. It is also to be understood that the server device 1706 can be the same as or similar to the server device 1402, the client node 1102, the validation node 1108, and/or the distributed ledger node 1110 and that the contactless card 1704 can be associated with a customer account of a bank or a company that issued the contactless card 1704.

In some embodiments, the server device 1706 can receive encrypted data, such as a cryptogram, from the contactless card 1704 via the mobile device 1702, for example, encrypted using systems and methods described herein in connection with FIGS. 1-12. For example, in some embodiments, a user can tap or otherwise bring the contactless card 1704 within a communication range of the mobile device 1702, and the mobile device 1702 can read the encrypted data from the contactless card 1704 and/or the contactless card 1704 can transmit the encrypted data to the mobile device 1702. In operation, the mobile device 1702 can transmit the encrypted data to the server device 1706, and the server device 1706 can decrypt the encrypted data to authenticate the contactless card 1704, for example, decrypted using systems and methods described herein in connection with FIGS. 1-12.

As explained above, the contactless card 1704 can be associated with the customer account. As such, in some embodiments, the server device 1706 can identify the customer account to authenticate the contactless card 1704. In particular, in some embodiments, the server device 1706 can decrypt protected data in the encrypted data and compare the protected data to record data associated with the customer account and stored on the server device 1706. When the protected data matches the record data, the server device 1706 can authenticate the contactless card 1704.

It is to be understood that, in some embodiments, the contactless card 1704 will not be authenticated unless registered with the server device 1706 so as to be associated with the customer account. In this regard, without such registration and association, the server device 1706 may not be capable of decrypting the encrypted data and/or the protected data in the encrypted data, for example, due to lacking required keys and the like. Additionally or alternatively, without such registration and association, the server device 1706 may be able to decrypt the encrypted data and/or the protected data in the encrypted data, but may not be able to match the protected data to any record data stored for registered cards. In this regard, the contactless card 1704 can be associated with the customer account in a database or a data store maintained by the server device 1706. As such, the mobile device 1702 can provide the encrypted data received from the contactless card 1704 as well identifying data, such as a user ID, to the server device 1706, and the server device 1706 can utilize such received information to identify the customer account and verify that the customer account is associated with the contactless card 1704.

The server device 1706 can also receive a URL from the contactless card 1704 via the mobile device 1702. For example, in some embodiments, the user can tap or otherwise bring the contactless card 1702 within the communication range of the mobile device 1702, and the mobile device 1702 can read the URL from the contactless card 1704 and/or the contactless card 1704 can transmit the URL to the mobile device 1702. In operation, the mobile device 1702 can transmit the URL to the server device 1706.

It is to be understood that the contactless card 1704 can transmit to the mobile device 1702 and/or the mobile device 1702 can read from the contactless card 1704 the encrypted data and the URL simultaneously or separately, for example, sequentially. Similarly, it is to be understood that the mobile device 1702 can transmit the encrypted data and the URL to the server device 1706 simultaneously or separately, for example, sequentially.

In any embodiment, after the server device 1706 authenticates the contactless card 1704 and receives the URL, the server device 1706 can use machine learning to determine one or more functions most likely desired by the user and dynamically redirect the URL to a website or a mobile application on the mobile device 1702 for performing those functions. For example, in some embodiments, the website or the mobile application for performing the one or more functions most likely desired by the user can include a menu of choices corresponding to those functions. In any embodiment, the server device 1706 can transmit a link to the mobile device 1702, and the user can click on that link on the mobile device 1702 to access the website or the mobile application and/or the website or the mobile application can enable the user to click therein or thereon to initiate, execute, and/or complete a transaction.

In some embodiments, the server device 1706 can rely on one or more user datapoints to determine the one or more functions most likely desired by by the user. That is, the one or more user datapoints can inform the machine learning. Exemplary user datapoints can include a customer status (e.g., new, existing, digitally active, app user, etc.), a customer log in history, a customer transaction history, a customer mobile phone type, customer discounts redeemed, customer points usage, website or mobile applications visited, and the like. In these embodiments, the server device 1706 can receive at least some of the one or more user datapoints from the mobile device 1702 and/or from a database on or accessible by the server device 1706 that stores information associated with the customer account associated with the contactless card 1704.

Additionally or alternatively, in some embodiments, the server device 1706 can rely on non-user specific datapoints to determine the one or more functions most likely desired by the user. That is, the one or more non-user specific datapoints can inform the machine learning. Exemplary non-user specific datapoints can include a time of day, a location, and the like.

In some embodiments, the server device 1706 can also implement feedback loops for training the machine learning. For example, in some embodiments, the server device 1706 can determine whether dynamically redirecting the URL to the website or the mobile application on the mobile device leads to a successful transaction. Responsive thereto, the server device 1706 can update the machine learning.

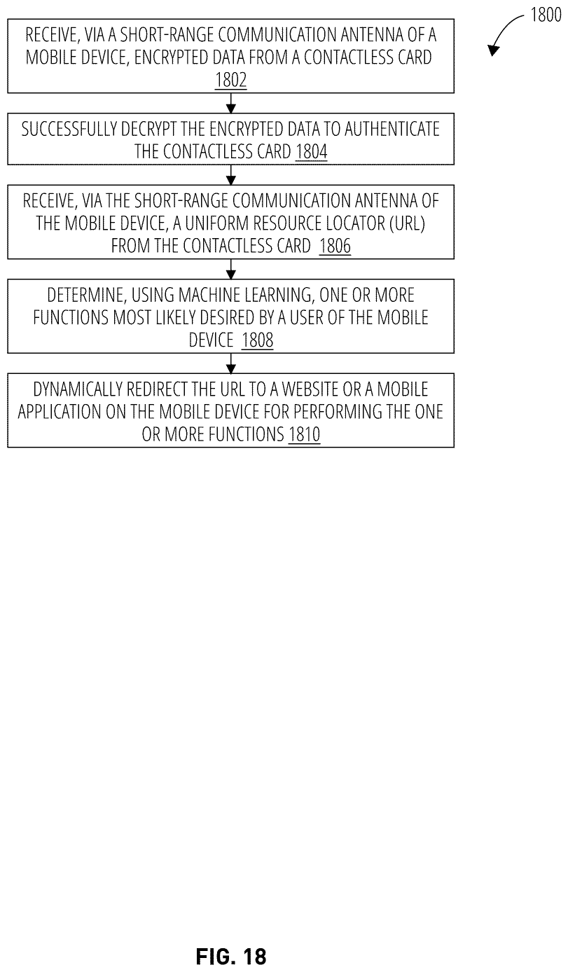

FIG. 18 is a flow chart that illustrates an example of a method 1800 in accordance with disclosed embodiments. In some embodiments, a server device, such as the server device 1402, the server device 1706, the client node 1102, the validation node 1108, and/or the distributed ledger node 1110, can execute some or all of the method 1800.

As seen, the method 1800 can include receiving, via a short-range communication antenna of a mobile device, encrypted data from a contactless card as in 1810, for example, encrypted using systems and methods described herein in connection with FIGS. 1-12, and successfully decrypting the encrypted data to authenticate the contactless card as in 1804, for example, decrypted using systems and methods described herein in connection with FIGS. 1-12. For example, in some embodiments, a user can tap or otherwise bring the contactless card within a communication range of the mobile device, the mobile device can read the encrypted data from the contactless card and/or the contactless card can transmit the encrypted data to the mobile device, and the mobile device can transmit the encrypted data to the server device.

The contactless card can be associated with a customer account. As such, in some embodiments, the customer account can be identified to authenticate the contactless card. In particular, in some embodiments, protected data in the encrypted data can be decrypted and compared to record data associated with the customer account. When the protected data matches the record data, the contactless card can be authenticated.

The method 1800 can also include receiving, via the short-range communication antenna of the mobile device, a URL from the contactless card as in 1806. For example, in some embodiments, the user can tap or otherwise bring the contactless card within the communication range of the mobile device, the mobile device can read the URL from the contactless card and/or the contactless card can transmit the URL to the mobile device, and the mobile device can transmit the URL to the server device.

It is to be understood that the contactless card can transmit to the mobile device and/or the mobile device can read from the contactless card the encrypted data and the URL simultaneously or separately, for example, sequentially. Similarly, it is to be understood that the mobile device can transmit the encrypted data and the URL to the server device simultaneously or separately, for example, sequentially. As such, in some embodiments, the user need only tap or otherwise bring the contactless card within the communication range of the mobile device once to initiate the contactless card transmitting and/or the mobile device reading the encrypted data and the URL.

After authenticating the contactless card as in 1804 and receiving the URL as in 1806, the method 1800 can include determining, using machine learning, one or more functions most likely desired by a user of the mobile device as in 1808 and dynamically redirecting the URL to a website or a mobile application on the mobile device for performing those functions as in 1810. For example, in some embodiments, the server device can transmit a link to the mobile device on which the user can click to access the website or the mobile application on the mobile device and/or the website or the mobile application can enable the user to click therein or thereon to initiate, execute, and/or complete a transaction.

In some embodiments, the method 1800 can rely on one or more user datapoints to determine the one or more functions most likely desired by by the user of the mobile device. As such, in some embodiments, the method 1800 can receive or retrieve at least some of the one or more user datapoints from the mobile device and/or from a database storing information associated with a customer account associated with the contactless card.

In some embodiments, the method 1800 can implement feedback loops for training the machine learning. As such, in some embodiments, the method 1800 can determine whether dynamically redirecting the URL to the website or the mobile application on the mobile device leads to a successful transaction and, responsive thereto, update the machine learning.

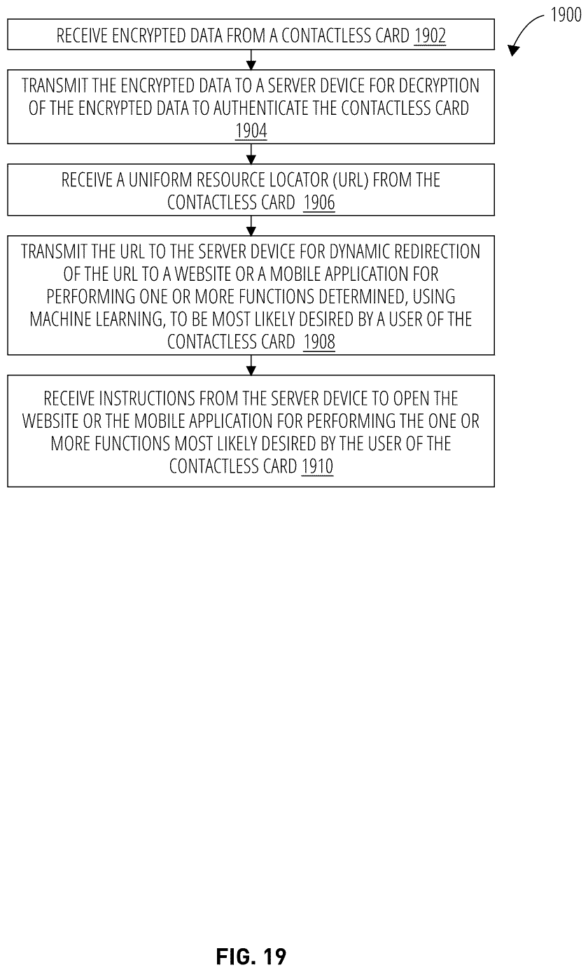

FIG. 19 is a flow chart that illustrates an example of a method 1900 in accordance with disclosed embodiments. In some embodiments, a mobile device, such as the the mobile device 1702, the mobile device 1302, and/or the client device 1114, can execute some or all of the method 1900.

As seen, the method 1900 can include receiving encrypted data from a contactless card as in 1902, for example, encrypted using systems and methods described herein in connection with FIGS. 1-12. In some embodiments, the encrypted data can be received via a short-range communication antenna of the mobile device. For example, in some embodiments, a user can tap or otherwise bring the contactless card within a communication range of the mobile device, and the mobile device can read the encrypted data from the contactless card and/or the contactless card can transmit the encrypted data to the mobile device. Then, the method 1900 can include transmitting the encrypted data to a server device for decryption of the encrypted data to authenticate the contactless card as in 1904.

The contactless card can be associated with a customer account. As such, in some embodiments, the customer account can be identified to authenticate the contactless card. In particular, in some embodiments, protected data in the encrypted data can be decrypted, for example, decrypted using systems and methods described herein in connection with FIGS. 1-12, and compared to record data associated with the customer account. When the protected data matches the record data, the contactless card can be authenticated.

The method 1900 can also include receiving a URL from the contactless card as in 1906. In some embodiments, the URL can be received via the short-range communication antenna of the mobile device. For example, in some embodiments, the user can tap or otherwise bring the contactless card within the communication range of the mobile device, and the mobile device can read the URL from the contactless card and/or the contactless card can transmit the URL to the mobile device.

It is to be understood that the contactless card can transmit to the mobile device and/or the mobile device can read from the contactless card the encrypted data and the URL simultaneously or separately, for example, sequentially. Similarly, it is to be understood that the mobile device can transmit the encrypted data and the URL to the server device simultaneously or separately, for example, sequentially. As such, in some embodiments, the user need only tap or otherwise bring the contactless card within the communication range of the mobile device once to initiate the contactless card transmitting and/or the mobile device reading the encrypted data and the URL.

In any embodiment, the method 1900 can include transmitting the URL to the server device for dynamic redirection of the URL to a website or a mobile application for performing one or more functions determined, using machine learning, to be most likely desired by a user of the contactless card as in 1908. In some embodiments, the server device can rely on one or more user datapoints to determine the one or more functions most likely desired by by the user of the mobile device. As such, in some embodiments, the method 1900 can include transmitting the one or more user datapoints from the mobile device to the server device.

Finally, the method 1900 can include receiving instructions from the server device to open the website or the mobile application for performing the one or more functions most likely desired by the user of the contactless card as in 1910. For example, in some embodiments, the method 1900 can include receiving a link that the user can click to access the website or the mobile application on the mobile device. Additionally or alternatively, in some embodiments, the method 1900 can include receiving instructions for automatically opening or loading the website or the mobile application on the mobile device.

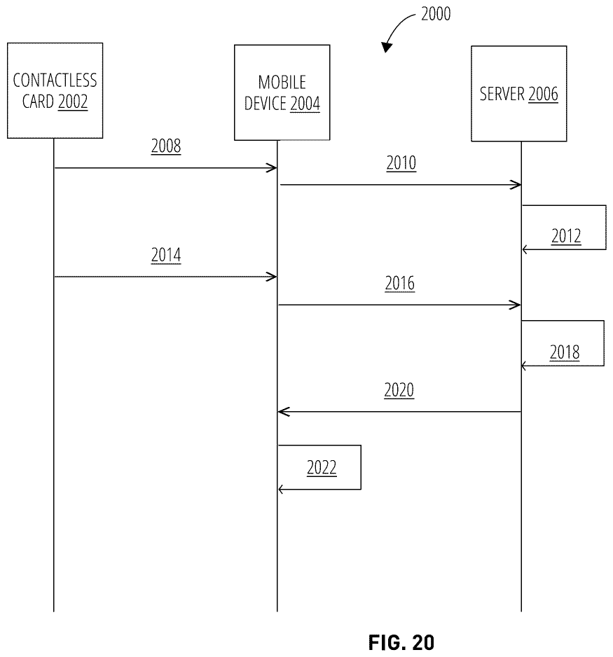

FIG. 20 illustrates an example of a sequence flow 2000 in accordance with disclosed embodiments. A contactless card 2002 can be the same as or similar to the contactless card 1704. Further, a mobile device 2004 can be the same as or similar to the mobile device 1702, the mobile device 1302, and/or the client device 1114. Still further, a server 2006 can be the same as or similar to the server device 1706, the server device 1402, the client node 1102, the validation node 1108, and/or the distributed ledger node 1110, and in some embodiments, the server 2006 can perform decryption and/or authentication.

The contactless card 2002 can be tapped on or brought within a communication range of the mobile device 2004 and can exchange information with the mobile device 2004. Line 2008 can represent communication between the contactless card 2002 and the mobile device 2004 and can include encrypted data, such as a cryptogram, stored on the contactless card 2002 and provided to the mobile device 2004. In some embodiments, protected data in the encrypted data can be encrypted using systems and methods described herein, for example, as discussed in FIGS. 1-12.

In some embodiments, communications between the contactless card 2002 and the mobile device 2004 can include NFC in accordance with one or more NFC protocols. However, embodiments disclosed herein are not so limited and can include other wireless technologies in addition to or as an alternative to NFC, such as other short-range communication protocols.

In some embodiments, the mobile device 2004 can operate as a pass-through device and, at 2010, transmit the encrypted data and other data, such as a user ID, to the server 2006. Line 2010 can represent such communication between the mobile device 2004 and the server 2006.

Upon receipt of the encrypted data, the server 2006 can decrypt the encrypted data to authenticate the contactless card 2002 at 2012, for example, as discussed in FIGS. 1-12. In some embodiments, the server 2006 can use some of the other data received from the mobile device 2004 to identify a customer account associated with the contactless card 2002. In some embodiments, the server 2006 can decrypt protected data in the encrypted data and compare the protected data to record data associated with the customer account and stored on the server 2006. When the protected data matches the record data, the server 2006 can authenticate the contactless card 2002.

As explained above, the contactless card 2002 can be tapped on or brought within the communication range of the mobile device 2004 and can exchange information with the mobile device 2004. Line 2014 can also represent communication between the contactless card 2002 and the mobile device 2004 and can include a URL stored on the contactless card 2002 and provided to the mobile device 2004. As above, in some embodiments, the mobile device 2004 can operate as a pass-through device and, at 2016, transmit the URL to the server 2006. Line 2016 can represent such communication between the mobile device 2004 and the server 2006.

Although line 2008 and line 2014 are shown as separate communications in FIG. 20, it is to be understood that such communications can be simultaneous or separate, for example, sequential. Similarly, although line 2010 and line 2016 are shown as separate communications in FIG. 20, it is to be understood that such communications can also be simultaneous or separate, for example, sequential.

After authenticating the contactless card 2002 at 2012 and receiving the URL at 2016, the server 2006 can use machine learning to determine one or more functions most likely desired by a user of the mobile device 2004 at 2018. For example, in some embodiments, the server 2006 can rely on one or more user datapoints to determine the one or more functions most likely desired by the user of the mobile device 2004. As such, in these embodiments, the server 2006 can receive at least some of the one or more user datapoints from the mobile device 2004 and/or from a database storing information associated with the customer account associated with the contactless card 2002. Additionally or alternatively, in some embodiments, the server 2006 can rely on non-user specific datapoints to determine the one or more functions most likely desired by the user of the mobile device 2004.

In any embodiment, after the server 2006 determines the one or more functions most likely desired by the user of the mobile device 2004 at 2018, the server 2006 can dynamically redirect the URL to a website or a mobile application on the mobile device for performing the one or more functions most likely desired by the user at 2020. Line 2020 can represent such communication between the mobile device 2004 and the server 2006. For example, the server 2006 can transmit a link to the mobile device 2004 that can be displayed to the user on the mobile device at 2022, and the user can click link to access the website or the mobile application on the mobile device 2004. Additionally or alternatively, in some embodiments, the server 2006 can transmit instructions to the mobile device 2004 for automatically opening or loading the website or the mobile application on the mobile device 2004 at 2022.

In some embodiments, the server 2006 can also implement feedback loops for training the machine learning. For example, in some embodiments, the server 2006 can determine whether dynamically redirecting the URL to the website or the mobile application on the mobile device 2004 leads to a successful transaction and responsive thereto, update the machine learning for future use.

It is to be understood that the server 2006 can process any data, information, and/or requests received from the mobile device 2004 either partially or fully. For example, in some embodiments, the server 2006 can decrypt the encrypted data. Additionally or alternatively, in some embodiments, the server 2006 can determine the one or more functions most likely desired by the user of the mobile device 2004 and dynamically redirect the URL to the website or the mobile application on the mobile device for performing the those functions.

It is also to be understood that the mobile device 2004 can communicate with the server 2006 via one or more wireless and/or wired connections. For example, in some embodiments, the mobile device 2004 can transmit any data, information, or requests to one or more application program interfaces hosted by the server 2006. Additionally or alternatively, in some embodiments, the mobile device 2004 can transmit any data, information, or requests to one or more application program interfaces hosted by a third party, such as a cloud-computing provider.

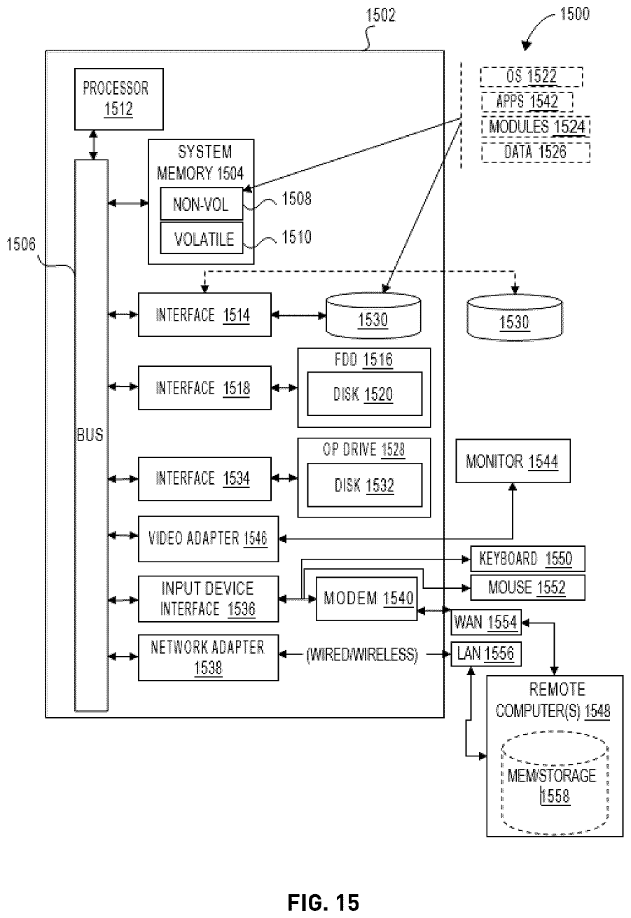

FIG. 15 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 1506 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), Peripheral Component Interconnect (PCI) Express, Personal Computer Memory Card International Association (PCMCIA), and the like.

The computing architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as ROM, RAM, dynamic RAM (DRAM), Double-Data-Rate DRAM (DDRAM), synchronous DRAM (SDRAM), static RAM (SRAM), programmable ROM (PROM), erasable programmable ROM (EPROM), EEPROM, flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

A computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 by a hard disk drive (HDD) interface 1514, and a floppy disk drive (FDD) interface 1518, and an optical disk drive interface 1534, respectively. The HDD interface 1514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and Wide Area Network (WAN) networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 can be operable to communicate with wired and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASICs), PLDs, DSPs, field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, ASICs, logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

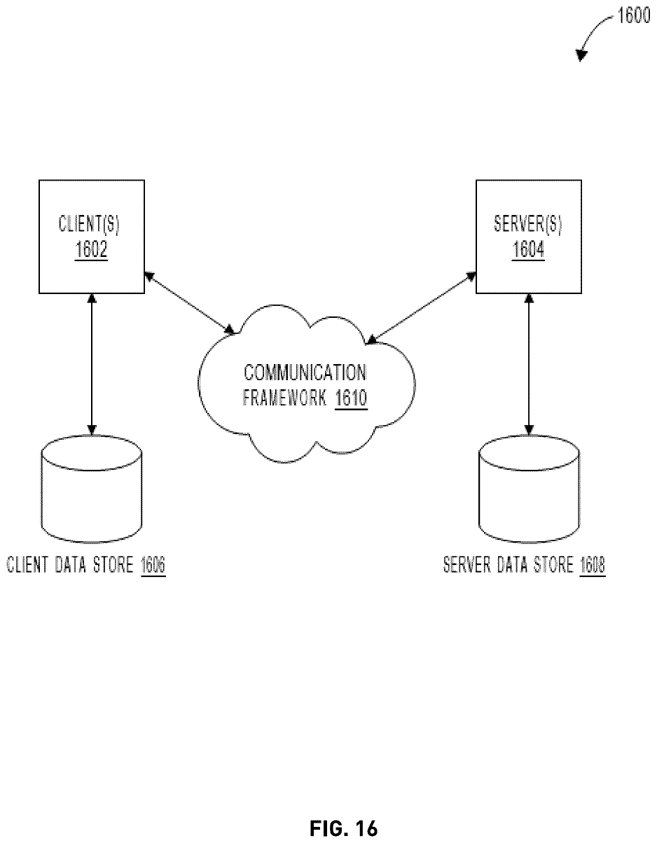

FIG. 16 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 16, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a PAN, a LAN, a Metropolitan Area Network (MAN), an Operating Missions as Nodes on the Internet (OMNI), a WAN, a wireless network, a cellular network, and other communications networks.

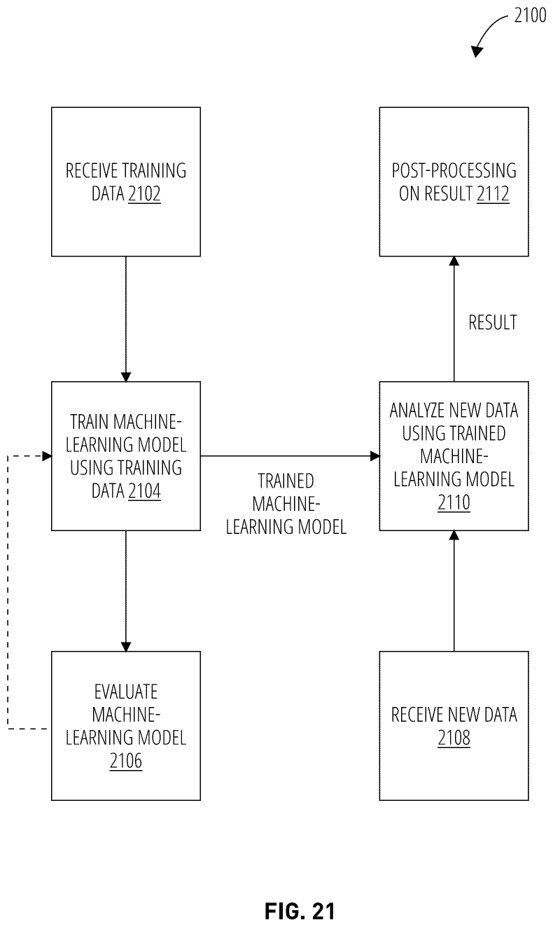

As explained above, systems and methods disclosed herein can use machine learning to determine one or more functions most likely desired by a user of a mobile device. In this regard, FIG. 21 is a flow chart of an example of a process 2100 for generating and using a machine-learning model according to some aspects discussed herein, e.g., detecting anomalies and a probability of occurrence.

Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Machine-learning models can be constructed through an at least partially automated (e.g., with little or no human involvement) process called training, as previously discussed. During training, input data, such as the sensor data from a mobile device and/or vehicle, vehicle information, and/or environmental data, can be iteratively supplied to a machine-learning model to enable the machine-learning model to identify patterns related to the input data or to identify relationships between the input data and output data. As discussed, embodiments include utilizing supervised and/or unsupervised training. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. The training may also incorporate a clustering technique to cluster or classify data into groups, e.g., customers with similar profiles.

In block 2102, training data is received. In some examples, the training data is received from a remote database or a local database (datastores), constructed from various subsets of data, e.g., sensor data, vehicle attribute data, environmental data, etc. or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model. In embodiments, the training data may include historical data based on data previously collected. For example, the historical data may include information such as, historical sensor data, historical vehicle attribute data, historical environmental data, etc. The historical data may also include the profile of the previous collected data. This information may be used to train the models to predict future and/or real-time anomalies, for example. Embodiments are not limited in this manner.

In block 2104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure. This may enable the machine-learning model to learn a mapping between the inputs and desired outputs. In unsupervised training, the training data includes inputs, but not desired outputs, so that the machine-learning model must find structure in the inputs on its own. In semi-supervised training, only some of the inputs in the training data are correlated to desired outputs.

In particular, a supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

Further, an unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Still further, semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

In block 2106, the machine-learning model is evaluated. For example, an evaluation dataset can be obtained, for example, via user input or from a database or datastore. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if the machine-learning model has an inadequate degree of accuracy for a particular task, the process can return to block 2104, where the machine-learning model can be further trained using additional training data or otherwise modified to improve accuracy. If the machine-learning model has an adequate degree of accuracy for the particular task, e.g., predicting anomalies, the process can continue to block 2108.

In block 2108, new data is received. In some examples, the new data is received from one or more mobile device, one or more contactless card, one or more server device, and/or one or more environmental system, as previously discussed. The new data may be unknown to the machine-learning model. For example, the machine-learning model may not have previously processed or analyzed the new data. The new data may include information about a vehicle and current environmental conditions, for example.

In block 2110, the trained machine-learning model is used to analyze the new data and provide a result, a detected anomaly and probability of occurrence. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 2112, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

What is claimed is:

1. A method comprising:
receiving, via a short-range communication antenna of a mobile device, encrypted data from a contactless card;
successfully decrypting the encrypted data to authenticate the contactless card;
receiving, via the short-range communication antenna of the mobile device, a uniform resource locator (URL) from the contactless card;
determining, using machine learning, one or more functions most likely desired by a user of the mobile device; and
dynamically redirecting the URL to a website or a mobile application on the mobile device for performing the one or more functions most likely desired by the user of the mobile device.

2. The method of claim 1 further comprising:
relying on one or more user datapoints to determine the one or more functions most likely desired by the user of the mobile device.

3. The method of claim 2 further comprising:
relying on one or more non-user specific datapoints to determine the one or more functions most likely desired by the user of the mobile device.

4. The method of claim 2 further comprising:
receiving the one or more user datapoints from the mobile device.

5. The method of claim 2 further comprising:
receiving the one or more user datapoints from a database storing information associated with a customer account associated with the contactless card.

6. The method of claim 1 wherein the website or the mobile application for performing the one or more functions most likely desired by the user of the mobile device includes a menu of choices corresponding to the one or more functions most likely desired by the user of the mobile device.

7. The method of claim 1 further comprising:
determining whether dynamically redirecting the URL to the website or the mobile application on the mobile device for performing the one or more functions most likely desired by the user of the mobile device leads to a successful transaction and, responsive thereto, updating the machine learning.

8. A non-transitory computer-readable medium comprising instructions that, when executed by a processor, cause the processor to:
receive, via a short-range communication antenna of a mobile device, encrypted data from a contactless card;
successfully decrypt the encrypted data to authenticate the contactless card;
receive, via the short-range communication antenna of the mobile device, a uniform resource locator (URL) from the contactless card;
determine, using machine learning, one or more functions most likely desired by a user of the mobile device; and
dynamically redirect the URL to a website or a mobile application on the mobile device for performing the one or more functions most likely desired by the user of the mobile device.

9. The non-transitory computer-readable medium of claim 8 wherein the instructions further cause the processor to rely on one or more user datapoints to determine the one or more functions most likely desired by the user of the mobile device.

10. The non-transitory computer-readable medium of claim 9 wherein the instructions further cause the processor to rely on one or more non-user specific datapoints to determine the one or more functions most likely desired by the user of the mobile device.

11. The non-transitory computer-readable medium of claim 9 wherein the instructions further cause the processor to receive the one or more user datapoints from the mobile device.

12. The non-transitory computer-readable medium of claim 9 wherein the instructions further cause the processor to receive the one or more user datapoints from a database storing information associated with a customer account associated with the contactless card.

13. The non-transitory computer-readable medium of claim 8 wherein the website or the mobile application for performing the one or more functions most likely desired by the user of the mobile device includes a menu of choices corresponding to the one or more functions most likely desired by the user of the mobile device.

14. The non-transitory computer-readable medium of claim 8 wherein the instructions further cause the processor to determine whether dynamically redirecting the URL to the website or the mobile application on the mobile device for performing the one or more functions most likely desired by the user of the mobile device leads to a successful transaction and, responsive thereto, update the machine learning.

15. A server device comprising:
a processor; and
a memory storing instructions that, when executed by the processor, cause the processor to:
receive, via a short-range communication antenna of a mobile device, encrypted data from a contactless card;
successfully decrypt the encrypted data to authenticate the contactless card;
receive, via the short-range communication antenna of the mobile device, a uniform resource locator (URL) from the contactless card;
determine, using machine learning, one or more functions most likely desired by a user of the mobile device; and
dynamically redirect the URL to a website or a mobile application on the mobile device for performing the one or more functions most likely desired by the user of the mobile device.

16. The server device of claim 15 wherein the instructions further cause the processor to rely on one or more user datapoints to determine the one or more functions most likely desired by the user of the mobile device.

17. The server device of claim 16 wherein the instructions further cause the processor to rely on one or more non-user specific datapoints to determine the one or more functions most likely desired by the user of the mobile device.

18. The server device of claim 16 wherein the instructions further cause the processor to receive the one or more user datapoints from the mobile device and a database storing information associated with a customer account associated with the contactless card.

19. The server device of claim 15 wherein the website or the mobile application for performing the one or more functions most likely desired by the user of the mobile device includes a menu of choices corresponding to the one or more functions most likely desired by the user of the mobile device.

20. The server device of claim 15 wherein the instructions further cause the processor to determine whether dynamically redirecting the URL to the website or the mobile application on the mobile device for performing the one or more functions most likely desired by the user of the mobile device leads to a successful transaction and, responsive thereto, update the machine learning.
